(19) United States
(12) Patent Application Publication
(10) Pub. No.: US 2025/0390996 A1
(43) Pub. Date: Dec. 25, 2025

(54) ADAPTIVE IMAGE SHARPENING

(71) Applicant: Intel Corporation, Santa Clara, CA (US)

(72) Inventors: Susanta Bhattacharjee, Bangalore (IN); Tamoghna Ghosh, Bangalore (IN); Neelanjan Bhattacharyya, Bangalore (IN); Geethacharan Rajagopalan, Gold River, CA (US)

(73) Assignee: Intel Corporation, Santa Clara, CA (US)

(21) Appl. No.: 19/311,995

(22) Filed: Aug. 27, 2025

(51) Int. Cl. G06T 5/73; G06T 5/60; G06T 5/70

(52) U.S. Cl. CPC G06T 5/73; G06T 5/60; G06T 5/70; G06T 2207/20081

(57) ABSTRACT

Systems, apparatus, articles of manufacture, and methods to implement adaptive image sharpening are disclosed. An example apparatus disclosed herein computes respective brightness parameters and respective contrast parameters for corresponding pixels of a first image. The disclosed example apparatus also determines respective sharpening strength parameters for the corresponding pixels based on the respective brightness parameters and the respective contrast parameters. The disclosed example apparatus further generate a second image based on the first image and the sharpening strength parameters.

### BACKGROUND

Applications for which compute devices render text as an image can suffer from compromised readability due to blurriness introduced in the displayed text. For instance, blurry text can be an issue during webcasts or live tutorials with shared presentations, video calls with whiteboard sessions, video games, or other scenarios in which the text displayed by the compute device is not computer-generated but is the result of being converted to or captured as an image.

### BRIEF DESCRIPTION OF THE DRAWINGS

FIG. 1 is a block diagram of an example environment in which an example compute device implements adaptive image sharpening in accordance with teachings of this disclosure.

FIG. 2 is a block diagram of an example implementation of adaptive image sharpening circuitry including in the compute device of FIG. 1.

FIG. 3 illustrates an example training procedure implemented by example model training circuitry included in an example server of FIG. 1.

FIGS. 4-6 illustrate example training image generation procedures implemented by the model training circuitry of FIG. 1.

FIG. 7 illustrates an example loss calculation procedure implemented by the model training circuitry of FIG. 1.

FIGS. 8-9 illustrate example look-up tables of reference sharpening strength parameters generated by example look-up table generation circuitry included in the server of FIG. 1 and deployable to the compute device of FIG. 1 for use by the adaptive image sharpening circuitry.

FIGS. 10-13 are flowcharts representative of example machine-readable instructions and/or example operations that may be executed, instantiated, and/or performed by example programmable circuitry to implement the adaptive image sharpening circuitry and, more generally, the compute device of FIGS. 1-2.

FIGS. 14-16 are flowcharts representative of example machine-readable instructions and/or example operations that may be executed, instantiated, and/or performed by example programmable circuitry to implement the model training circuitry and/or the look-up table generation circuitry, and more generally, the server of FIG. 1.

FIG. 17 is a block diagram of an example processing platform including programmable circuitry structured to execute, instantiate, and/or perform the example machine-readable instructions and/or perform the example operations of FIGS. 10-13 to implement the compute device 105 of FIGS. 1-2.

FIG. 18 is a block diagram of an example processing platform including programmable circuitry structured to execute, instantiate, and/or perform the example machine-readable instructions and/or perform the example operations of FIGS. 14-16 to implement the server of FIG. 1.

FIG. 19 is a block diagram of an example implementation of the programmable circuitry of FIGS. 17 and/or 18.

FIG. 20 is a block diagram of another example implementation of the programmable circuitry of FIGS. 17 and/or 18.

FIG. 21 is a block diagram of an example software/firmware/instructions distribution platform (e.g., one or more servers) to distribute software, instructions, and/or firmware (e.g., corresponding to the example machine-readable instructions of FIGS. 10-16) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

Applications for which compute devices render text as an image can suffer from compromised readability due to blurriness introduced in the displayed text. For instance, blurry text can be an issue during webcasts or live tutorials with shared presentations, video calls with whiteboard sessions, video games, or other scenarios in which the text displayed by the compute device is not computer-generated but is the result of being converted to or captured as an image. Known image sharpening techniques can enhance the perceived visual quality of graphical content in images and video. However, at least some such existing image sharpening techniques may be inadequate for effective text sharpening because they fail to dynamically adjust sharpening strength based on the specific content of the image, leading to suboptimal text readability and overall image quality.

In contrast, example adaptive image sharpening techniques disclosed herein determine the sharpening strengths for individual pixels of an image dynamically based on local contrast and local brightness parameters computed for the individual pixels. In some examples, these local contrast and local brightness parameters are used to index a two-dimensional (2D) data structure, such as a 2D look-up table (LUT), implemented in the display engine hardware of the compute device and storing reference sharpening strength parameters derived from an offline artificial intelligence (AI) model. In this way, example adaptive image sharpening techniques can produce sharpened images with improved text readability through the power of AI processing, but without the computational and energy overhead of real-time AI model execution. Also, the reference sharpening strength parameters stored in the 2D data structure (e.g., 2D LUT) can be tailored for specific use-cases, such as by training the offline AI model to provide a first 2D LUT targeted for gaming scenarios, provide a second 2D LUT targeted for video calls/webcasts, etc., which can be accessed by the compute device based on the application context. Furthermore, the offline AI model can be trained to provide reference sharpening strength parameters tailored to be used with image up-scaling algorithms, such as super resolution algorithms, to sharpen the up-scaler output and improve visual quality. Moreover, through comprehensive AI model training, example adaptive image sharpening techniques disclosed herein can yield enhanced text sharpening clarity with few if any artifacts and without excessive computational overhead, while also maintaining satisfactory sharpening quality for natural and rendered pictures.

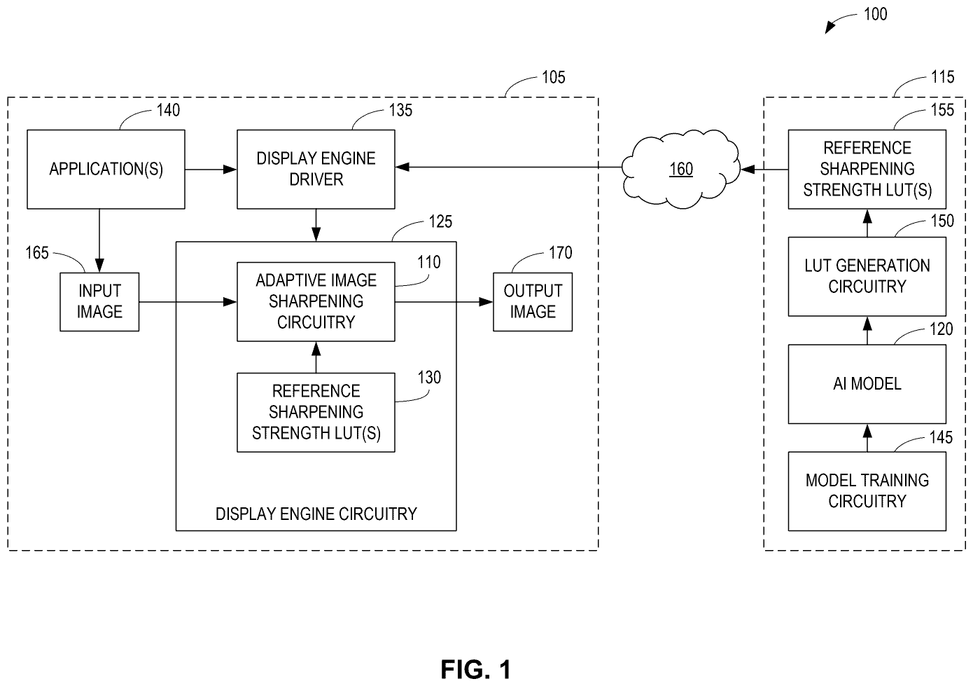

Turning to the figures, FIG. 1 is a block diagram of an example environment 100 in which an example compute device 105 performs adaptive image sharpening in accordance with teachings of this disclosure. The compute device 105 of the illustrated example includes example adaptive image sharpening circuitry 110, example display engine circuitry 125, one or more example reference sharpening strength LUTs 130, an example display engine driver 135 and one or more example applications 140. The example environment 100 also include an example server 115, which includes an example AI model 120, example model training circuitry 145, example LUT generation circuitry 150 and one or more example reference sharpening strength LUTs 155. One or more of the adaptive image sharpening circuitry 110, the display engine circuitry 125, the reference sharpening strength LUT(s) 130, the display engine driver 135, the application(s) 140, the AI model 120, the model training circuitry 145, the LUT generation circuitry 150, and/or the reference sharpening strength LUT(s) 155 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, one or more of the adaptive image sharpening circuitry 110, the display engine circuitry 125, the reference sharpening strength LUT(s) 130, the display engine driver 135, the application(s) 140, the AI model 120, the model training circuitry 145, the LUT generation circuitry 150, and/or the reference sharpening strength LUT(s) 155 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The compute device 105 of the illustrated example can correspond to any type of compute device. For example, the compute device 105 can be a personal computer, a workstation, a server, a self-learning machine (e.g., a neural network), a mobile device (e.g., a cell phone, a smart phone, a tablet such as an iPad™), a personal digital assistant (PDA), an Internet appliance, a digital versatile disk (DVD) player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device. The server 115 of the illustrated example can be implemented by any compute device, such as any of the foregoing examples of compute devices. In some examples, the server 115 is implemented by a cloud computing facility or any other type of data processing facility. In the example environment 100 of FIG. 1, the compute device 105 and the server 115 communicate via an example network 160. The example network 160 can be implemented by any type or combinations of networks. For example, the network 160 can be the Internet, a private network, etc.

In the illustrated example, the display engine circuitry 125 of the compute device 105 reads an example input image 165 from memory and processes the input image 165 to generate a corresponding example output image 170, which the display engine circuitry 125 can provide to a display device for presentation, stream to a destination device, store in memory, etc. For example, the input image 165 can be a single image (e.g., a photograph, a display background, a presentation slide, etc.), a video frame (e.g., corresponding to a streaming video, a video game, etc.), etc. In the illustrated example, the input image 165 includes pixel data (pixels) generated by the application(s) 140 executed by the compute device 105. As such, the application(s) 140 may include any application capable of generating image and/or video data, such as a streaming application, a game application, a conferencing application, an office productivity application, etc.

The display engine circuitry 125 of the illustrated example includes circuitry to perform one or more processing operations on the input image 165 to generate the corresponding output image 170. For example, the display engine circuitry 125 can downscale the input image 165 to generate a lower resolution version of the image as the output image 170, upscale the input image 165 to generate a higher resolution version (e.g., super-resolution version) of the image as the output image 170, perform color correction on the input image 165 to generate the output image 170, etc., and/or any other processing operation or combination of operations on the input image 165 to generate the output image 170. The display engine circuitry 125 of the illustrated example also includes the adaptive image sharpening circuitry 110 to sharpen the input image 165 to generate the corresponding output image 170.

The adaptive image sharpening circuitry 110 of the illustrated example implements a form of image sharpening that is based on unsharp masking. Some unsharp masking algorithms generate a sharpened output image from an original input image based on the procedure represented mathematically by Equation 1:

$$sharpened = original + ( original - blurred ) \times s \qquad Equation 1$$

In Equation 1, the original input image is represented by the variable “original,” the sharpened output image is represented by the variable “sharpened,” and the variable “blurred” represents a blurred image generated by blurring the original input image, such as with a blurring filter, a blurring kernel, etc. In Equation 1, the parameter “s” represents the sharpening strength parameter.

In some image sharpening algorithms, the sharpening strength parameter, s, is positive or non-negative (e.g., s≥0) and can be a local function based on pixel attributes and, thus, not constant across the image. In some such examples, the sharpening strength parameter, s, for a given pixel, p, of the input image is computed according to Equation 2:

$$s = Min ( Y ) \times {f}_{1} ( Max ( Y ) ) \qquad Equation 2$$

In Equation 2, the variable “Y” represents luminance values of a neighborhood of pixels including the given pixel, p, the function “Min(Y)” returns the minimum luminance value of the neighborhood of pixels, and the function “Max(Y)” returns the maximum luminance value of the neighborhood of pixels. In Equation 2, the function “f₁” is a non-linear function, which in some examples is approximated as a one dimension (1D) look-up table (LUT).

In contrast with the foregoing image sharpening algorithms, the adaptive image sharpening circuitry 110 implements an adaptive image sharpening algorithm that determines the sharpening strength parameter, s, for a given pixel, p, of the input image based on a local brightness parameter and a local contrast parameter computed for that given pixel. In some examples, the adaptive image sharpening circuitry 110 implements such an adaptive image sharpening algorithm that is represented mathematically by Equation 3:

$$sharpened ( x , y ) = original ( x , y ) + ( original ( x , y ) - blurred ( x , y ) ) \times s ( {B}_{xy} , {C}_{xy} ) \qquad Equation 3$$

In Equation 3, “(x,y)” denotes the pixel coordinates of the given pixel, p, and, thus, the given pixel of the original input image is represented by the variable “original(x, y),” the corresponding pixel of the sharpened output image is represented by the variable “sharpened(x, y),” and the corresponding pixel of the blurred image is represented by the variable “blurred(x, y).” As described above, the adaptive image sharpening circuitry 110 generates the blurred image by blurring the original input image, such as with a blurring filter, a blurring kernel, etc. In Equation 3, the variables “B_{xy}” and “C_{xy}” denote the local brightness parameter and the local contrast parameter, respectively, computed for the given pixel, p, at the pixel location x,y. In Equation 3, the function “s(B_{xy}, C_{xy})” represents the sharpening strength parameter determined for the given pixel, p, at the pixel location x,y, and is based on (e.g., a function of) the local brightness parameter, B_{xy}, and the local contrast parameter, C_{xy}, for the given pixel at the pixel location x,y.

Example techniques for computing the local brightness parameter, B_{xy}, and the local contrast parameter, C_{xy}, for the given pixel at the pixel location x,y are described in detail below. Also, in some examples, the sharpening strength parameter, s(B_{xy}, C_{xy}), can take on positive or negative values. For example, the sharpening strength parameter, s(B_{xy}, C_{xy}), for a given pixel at the pixel location x,y can have a value between negative one and positive one (e.g., −1≤s(B_{xy}, C_{xy})≤1), which is unlike other image sharpening algorithms in which the sharpening strength is restricted to being a positive or non-negative value (e.g., s≥0).

Using a sharpening strength parameter that is determined based on a pixel's local brightness and local contrast can provide several benefits. For example, in low contrast regions of an input image, such as where there are few if any edges, sharpening may not be useful. Also, sharpening dark regions of an input image may yield undesirable results, such as enhancing noise. By determining the sharpening strength parameter, s(B_{xy}, C_{xy}), for a given pixel as a function of local contrast and local brightness, such undesirable results can be avoided.

In the illustrated example of FIG. 1, the AI model 120 implemented by the server 115 is used to learn the relationship s(B_{xy}, C_{xy}) between the combination of local contrast and local brightness of a given pixel to the sharpening strength parameter for that given pixel. In the illustrated example, this learned relationship is then implemented by the 2D reference sharpening strength LUT(s) 130 in the display engine circuitry 125, enabling precise and effective sharpening tailored to the specific content of the input image 165.

The AI model 120 implemented by the server 115 can be any implemented by any type of artificial intelligence, including machine learning (ML), deep learning (DL), and/or other artificial machine-driven logic. AI enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, the AI model 120 is structured to accept 2D arrays (e.g., represented as 2D images) of respective local contrast and local brightness parameters computed for the pixels of an input image, and output a 2D array (e.g., represented as a 2D image) of corresponding sharpening strength parameters for the pixels of the input image. In general, machine learning models/architectures that are suitable to use in the example approaches disclosed herein will be capable of processing 2D arrays of data, such as images. However, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using training images produced from corresponding ground-truth images. In examples disclosed herein, training is performed until a loss function converges. In examples disclosed herein, training is performed by the model training circuitry 145 of the server 115. Training is performed using hyperparameters that control how the learning is performed (e.g., a learning rate, a number of layers to be used in the machine learning model, etc.).

In the illustrated example, once training is complete, the AI model 120 is deployed at the server 115 for use as an executable construct that processes an input and provides an output based on the network of nodes and connections defined in the model. The AI model 120 is stored at the server 115. As described in further detail below, the AI model 120 may then be executed by the LUT generation circuitry 150 to generate a reference sharpening strength LUT 155 that maps input combinations of local brightness and local contrast to corresponding output sharpening strength parameters, thereby providing a LUT-based implementation of the function s(B_{xy}, C_{xy}) of Equation 3. In some examples, the LUT generation circuitry 150 also causes the reference sharpening strength LUT 155 to be downloaded, transmitted or otherwise deployed to the compute device 105 and stored as a reference sharpening strength LUT 130 in the display engine circuitry 125 of the compute device 105.

Once trained, the deployed AI model 120 may be operated by the server 115 in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed AI model 120 may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, what constitutes a sharp image depends on the use-case. For example, the degree of sharpness desired in a shared presentation (e.g., with a substantial amount of text) over a video call may be different from the degree of sharpness desired in a game scene. As another example, if there are artifacts on the text of an original input image 165, then sharpening the image could make the artifacts more prominent, which may be undesirable. In such a use-case, a negative sharpening strength (e.g., s(B_{xy}, C_{xy})<0) can slightly blur the affected area of the image to reduce the artifacts and, thus, actually improve visual quality.

Therefore, the AI model 120 can be trained for a particular use-case, such as for use with a particular application 140, based on sample ground-truth images that exemplify what constitutes a sharp image for the given use-case. In the illustrated example, the model training circuitry 145 collects such a sample of ground-truth images from any appropriate repository accessible via the network 160. From these sharp, ground-truth images, the model training circuitry 145 of the server 115 then creates unsharp training images synthetically using one or more algorithms. For example, the model training circuitry 145 may create an unsharp training image from a corresponding ground-truth image by downscaling the ground-truth image to a lower resolution and then upscaling the downscaled image back to the original resolution to create the training image. Additionally or alternatively, the model training circuitry 145 may create an unsharp training image from a corresponding ground-truth image by applying lossy compression, such as JPEG compression, to the ground-truth image to create the training image. Additionally or alternatively, the model training circuitry 145 may create an unsharp training image from a corresponding ground-truth image using one or more blurring algorithms, such as a box blur algorithm, a Gaussian blur algorithm, etc., to blur the ground-truth image to create the training image. Thus, the respective pairs of sharp ground-truth images and corresponding unsharp training images constitute the training data set used by the model training circuitry 145 for training the AI model 120, and the model training circuitry 145 may choose the particular un-sharpening algorithm to be used to generate the unsharp images based on the specific use-case (e.g., application 140) to be targeted.

Next, the model training circuitry 145 of the server 115 trains the AI model 120 based on the training data set. In the illustrated example, model training circuitry 145 converts an input unsharp training image into a two-channel input image in which one channel contains the local brightness parameters computed by the model training circuitry 145 for the pixels of the training image and the other channel contains the local contrast parameters computed by the model training circuitry 145 for the pixels of the training image. In the illustrated example, the AI model 120 is implemented by a neural network architecture that accepts the two-channel input images (with one channel being the local brightness and the other channel being the local contrast) determined by the model training circuitry 145 from the respective training images, and outputs a single-channel output image that contains the respective sharpening strength parameters predicted by the AI model 120 for the corresponding pixels of the training images. Example procedures used by the model training circuitry 145 to compute the local brightness and local contrast parameters are described in detail below.

In the illustrated example, the model training circuitry 145 trains the AI model 120 by using the respective sharpening strength parameters output by the AI model 120 for a given input training image to generate a corresponding sharpened image according to Equation 3 above. The model training circuitry 145 then evaluates a loss function that compares the ground-truth image corresponding to the input training image to the sharpened image generated by Equation 3 using the respective sharpening strength parameters output by the AI model 120. The model training circuitry 145 uses the output of the loss function to train, or adapt, the parameters of the AI model 120 to learn the sharpening strength function (e.g., s(B_{xy}, C_{xy})) that dynamically adjusts the sharpening strength based on the local contrast and brightness of each pixel to achieve visual quality tailored for the use-case (e.g., application 140) represented by the training data set.

After the AI model 120 is trained, the LUT generation circuitry 150 of the server 115 uses the AI model 120 model to generate a 2D LUT 155, or any other data structure, that maps combinations of local contrast and local brightness index values to corresponding reference sharpening strength parameters provided by the AI model 120 model. The LUT generation circuitry 150 then causes the server 115 to download, transmit or otherwise deploy the 2D LUT 155 to the compute device 105 via the network 160 (e.g., in response to a request from the display engine driver 135 of the compute device 105). The compute device 105 implements the downloaded/deployed 2D LUT as the 2D LUT 130 implemented in the display engine circuitry 125, thereby allowing for real-time adaptive sharpening without the computational overhead of implementing the AI model 120 locally at the compute device 105.

In some examples, the model training circuitry 145 trains the AI model 120 using different training data sets tailored to different image sharpening use-cases (e.g., applications 140) to enable generation of multiple different 2D LUTs 155 each tuned for a different one of the image sharpening use-cases (e.g., applications 140). For example, the model training circuitry 145 may train the AI model 120 based on a first training data set to enable generation of a first 2D LUT 155 for gaming scenarios, and train the AI model 120 based on a second training data set to enable generation of a second 2D LUT 155 for video calls/webcasts, and train the AI model 120 based on a third training data set to enable generation of a third 2D LUT 155 for use with image up-scalers (e.g., super-resolution accelerators) to sharpen the up-scaler output and improve visual quality, etc. In some such examples, the display engine driver 135 of the compute device 105 can request a particular 2D LUT 155 from the server 115 that is tailored or tuned to a particular application 140 being executed by the compute device 105 to generate the input images 165 to be processed by the display engine circuitry 125. In such examples, the display engine driver 135 can then cause the requested 2D LUT 155 to be stored in the display engine circuitry 125 as the 2D LUT 130 that is accessible by the adaptive image sharpening circuitry 110. In some examples, the display engine driver 135 can request multiple different 2D LUTs 155 tailored to multiple different applications 140 from the server 115 during an initialization operation (e.g., at boot-up) and then download the multiple different 2D LUTs 155 to the display engine circuitry 125 for storage as a library of the 2D LUTs 130. In such examples, the display engine driver 135 can instruct the display engine circuitry 125 to activate a particular one of the 2D LUTs 130 from the stored library based on the particular application 140 being executed.

In summary, adaptive image sharpening, as implemented by the compute device 105 and the server 115 in the example environment 100 of FIG. 1, provides several novel features over other image sharpening techniques. For example, adaptive image sharpening, as implemented in the example environment 100 of FIG. 1, uses a novel combination of local brightness and local contrast as two inputs to the 2D reference sharpening strength LUT(s) 130 to obtain corresponding sharpening strength parameters for pixels of an image. Also, adaptive image sharpening, as implemented in the example environment 100 of FIG. 1, uses AI-based learnable 2D reference sharpening strength LUT(s) 130, which can be trained based on multiple distinct use-cases. Furthermore, adaptive image sharpening, as implemented in the example environment 100 of FIG. 1, enables dynamic configuration of multiple AI-driven 2D reference sharpening strength LUTs, allowing seamless adaptation to various applications in real-time. For example, a 2D reference sharpening strength LUT suitable to online presentations may not be suitable for gaming workloads. Through offline AI training, a library of trained reference sharpening strength LUTs for different scenarios can be created, and a display engine driver 135 can load a particular reference sharpening strength LUT based on use-case.

In this way, adaptive image sharpening, as implemented by the compute device 105 and the server 115 in the example environment 100 of FIG. 1, can provide advantages over other image sharpening techniques. For example, adaptive image sharpening, as implemented in the example environment 100 of FIG. 1, can dynamically adjust sharpening based on local contrast and local brightness of an image, thereby reducing unnecessary sharpening and artifacts relative to other sharpening algorithms. Also, adaptive image sharpening, as implemented in the example environment 100 of FIG. 1, utilizes an offline-trained AI model that revolutionizes image enhancement by generating specialized 2D reference sharpening strength LUTs for distinct applications. For example, adaptive image sharpening, as implemented in the example environment 100 of FIG. 1, can produce unique reference sharpening strength LUTs for text images, gaming scenarios, video conferencing/webcasts etc., providing enhanced versatility and adaptability relative to other image sharpening algorithms. Furthermore, adaptive image sharpening, as implemented in the example environment 100 of FIG. 1, can be used in conjunction with display up-scalars for high-quality image upscaling.

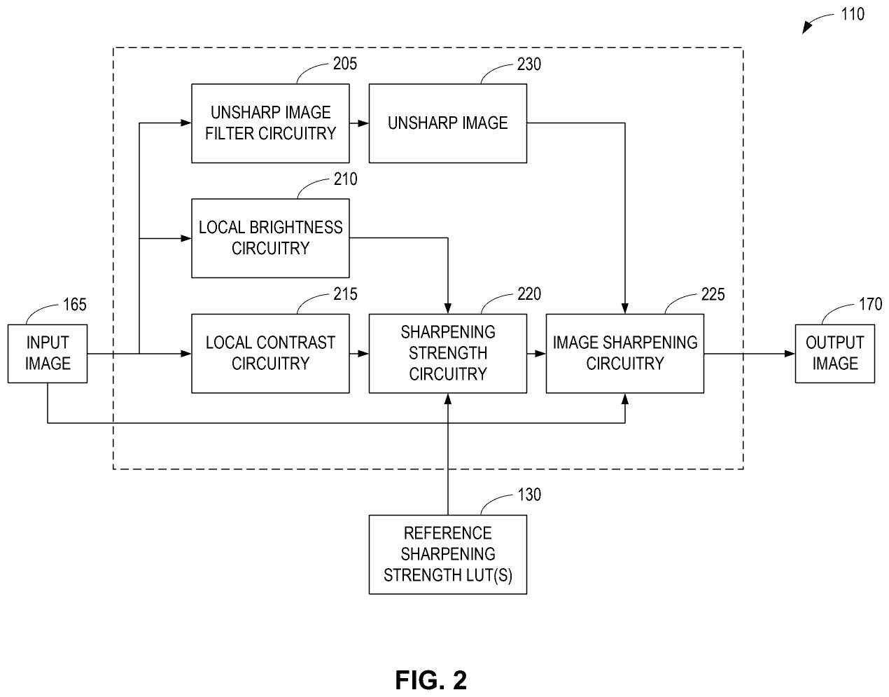

FIG. 2 is a block diagram of an example implementation of the adaptive image sharpening circuitry 110 of FIG. 1. The adaptive image sharpening circuitry 110 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSC), etc. Additionally or alternatively, the adaptive image sharpening circuitry 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example adaptive image sharpening circuitry 110 of FIG. 2 includes example unsharp image filter circuitry 205, example local brightness circuitry 210, example local contrast circuitry 215, example sharpening strength circuitry 220 and example image sharpening circuitry 225. As discussed above, the adaptive image sharpening circuitry 110 sharpens the original input image 165 based on the algorithm represented in Equation 3 to generate the sharpened output image 170. As such, the original input image 165 corresponds to the variable original(x, y) in Equation 3 and the sharpened output image 170 corresponds to the variable sharpened(x, y) of Equation 3. Furthermore, in the illustrated example, the adaptive image sharpening circuitry 110 performs adaptive image sharpening of the luminance (Y) component of the original input image 165 and leaves the chrominance components (UV) of the original input image 165 unchanged. In such examples, the variable original(x, y) in Equation 3 corresponds to the luminance component (Y) of the original input image 165 and the variable sharpened(x, y) in Equation 3 corresponds to the luminance component (Y) of the sharpened output image 170. In the illustrated example, the adaptive image sharpening circuitry 110 combines the luminance component (Y) of the sharpened output image 170 (represented as sharpened(x, y) in Equation 3) with the unchanged chrominance components (UV) of the original input image 165 to obtain the overall sharpened output image 170.

The unsharp image filter circuitry 205 of the illustrated example blurs or otherwise processes the original input image 165 (represented as original(x, y) in Equation 3) to generate an example blurred image 230, also referred to as an example unsharp image 230, corresponding to the original input image 165. As such, the unsharp image 230 corresponds to the variable “blurred(x, y)” of Equation 3. In examples in which the adaptive image sharpening circuitry 110 performs adaptive image sharpening of the luminance (Y) component of the original input image 165 and leaves the chrominance components (UV) of the original input image 165 unchanged, the unsharp image filter circuitry 205 of the illustrated example blurs or otherwise processes the luminance component (Y) of the original input image 165 to generate the blurred image 230, or unsharp image 230, which corresponds to the variable “blurred(x, y)” of Equation 3.

In some such examples, the unsharp image filter circuitry 205 converts the original input image 165 from an RGB format, which includes red, blue and green pixel components, to a YUV/YCbCr format that includes luminance (Y) and chrominance (UV/CbCr) components. In some such examples, the unsharp image filter circuitry 205 filters the luminance component (Y) of the original input image 165 (represented as original(x, y) in Equation 3) with a blur filter that has programmable filter coefficients to produce the blurred image 230. In some examples, the size of the blur filter used by the unsharp image filter circuitry 205 is configurable by, for example, the display engine driver 135 based on a resolution of the original input image 165. For example, the blur filter may be a 2D filter with a maximum filter window size of N×N coefficients, such as 5×5 coefficients or some other size. For high resolution images, such as 4K images, the display engine driver 135 may configure (e.g., program) the blur filter with coefficients that fill the full size of the blur filter (e.g., 5×5 coefficients). However, for lower resolution images, such as image at or below 2.8K resolution, the display engine driver 135 may configure (e.g., program) the blur filter to have a smaller filter window size, such as 3×3 coefficients, by programming the center 3×3 coefficients and setting the outer coefficients to zero.

The local brightness circuitry 210 of the illustrated example computes the local brightness parameters of pixels of the original input image 165. As such, the local brightness parameters computed by the local brightness circuitry 210 correspond to the local brightness parameter B_{xy} of Equation 3. In the illustrated example, the local brightness circuitry 210 computes the local brightness parameter B_{xy} of a given pixel, p, at the location (x,y) based on an average of the luminance values of pixels in a neighborhood of pixels including the given pixel, p. In some examples, the average may be a weighted average of the pixel luminance values in the neighborhood of pixels. For example, the local brightness circuitry 210 can compute the local brightness parameter B_{xy} of a given pixel, p, at the location (x,y) by processing the luminance component of the original input image 165 with a Gaussian blur kernel centered at the pixel location (x,y) and having programmable coefficients and a configurable kernel window size.

An example Gaussian blur separable kernel used by the local brightness circuitry 210 to compute the local brightness parameter B_{xy} of a given pixel, p, at the location (x,y) is given by Equation 4:

$$( \begin{matrix}0.0625 & 0.125 & 0.0625 \\ 0.125 & 0.25 & 0.125 \\ 0.0625 & 0.125 & 0.0625\end{matrix} ) \qquad Equation 4$$

In some examples, the size of the Gaussian blur kernel used by the local brightness circuitry 210 is configurable by, for example, the display engine driver 135 based on a resolution of the original input image 165. For example, the Gaussian blur kernel may be a 2D kernel with a maximum kernel window size of M×M coefficients, such as 5×5 coefficients or some other size. For high resolution images, such as 4K images, the display engine driver 135 may configure (e.g., program) the Gaussian blur kernel with coefficients that fill the full size of the Gaussian blur kernel (e.g., 5×5 coefficients). However, for lower resolution images, such as image at or below 2.8K resolution, the display engine driver 135 may configure (e.g., program) the blur filter to have a smaller kernel window size, such as 3×3 coefficients, by programming the center 3×3 coefficients and setting the outer coefficients to zero. Also, the display engine driver 135 may program the same size or different sizes for the Gaussian blur kernel used by the local brightness circuitry 210 and the blur filter used by the unsharp image filter circuitry 205.

The local contrast circuitry 215 of the illustrated example computes the local contrast parameters of pixels of the original input image 165. As such, the local contrast parameters computed by the local contrast circuitry 215 correspond to the local contrast parameter C_{xy} of Equation 3. In the illustrated example, the local contrast circuitry 215 computes the local contrast parameter C_{xy} of a given pixel, p, at the location (x,y) based on the luminance values of pixels in a neighborhood of pixels including the given pixel, p. For example, the local contrast circuitry 215 can compute the local contrast parameter C_{xy} of a given pixel, p, at the location (x,y) based on the difference between the maximum and minimum luminance values of the pixels in a neighborhood of pixels including the given pixel, p, according to Equation 5:

$${C}_{x y} = Max ( {Y}_{n e i g h b o r h o o d} ) - Min ( {Y}_{n e i g h b o r h o o d} ) \qquad Equation 5$$

In Equation 5, “Y_{neighborhood}” represents the luminance values of a neighborhood of pixels including the given pixel, p, the function “Max(Y_{neighborhood})” represents the maximum value of that neighborhood of pixel luminance values, and “Min(Y_{neighborhood})” represents the minimum value of that neighborhood of pixel luminance values. In some examples, the neighborhood of pixels Y_{neighborhood} is based on a configurable window size.

In some examples, the size of the window used by the local contrast circuitry 215 to define a neighborhood of luminance values is configurable by, for example, the display engine driver 135 based on a resolution of the original input image 165. For example, the window size may have a maximum window size of L×L coefficients, such as 5×5 coefficients or some other size. For high resolution images, such as 4K images, the display engine driver 135 may configure (e.g., program) the window with values of one (1) that fill the full size of the window (e.g., 5×5 coefficients) such that the window will select a neighborhood of luminance values that fills the window. However, for lower resolution images, such as images at or below 2.8K resolution, the display engine driver 135 may configure (e.g., program) a smaller window size, such as 3×3 coefficients, by programming the center 3×3 coefficients to have values of one (1) and setting the outer coefficients to zero (0). Also, the display engine driver 135 may program the same size or different sizes for the Gaussian blur kernel used by the local brightness circuitry 210, the neighborhood selection window used by the local contrast circuitry 215 and/or the blur filter used by the unsharp image filter circuitry 205.

The sharpening strength circuitry 220 of the illustrated example computes sharpening strength parameters for pixels of the original input image 165. As such, the sharpening strength parameters computed by the sharpening strength circuitry 220 correspond to the sharpening strength parameter s(B_{xy}, C_{xy}) of Equation 3. In the illustrated example, the sharpening strength circuitry 220 computes the sharpening strength parameters s(B_{xy}, C_{xy}) based on 2D reference sharpening strength LUT(s) 130 implemented in the display engine circuitry 125 of the compute device 105. As described above, a given 2D reference sharpening strength LUT 130 is a 2D LUT, or any other data structure, that maps combinations of local contrast and local brightness index values to corresponding reference sharpening strength parameters provided by the AI model 120 model of the server 115. Although described as 2D LUTs in the illustrated example, the 2D reference sharpening strength LUT(s) 130 can be implemented as any data structure capable of mapping combinations of local contrast and local brightness index values to corresponding reference sharpening strength parameters. For example, the 2D reference sharpening strength LUT(s) 130 can be implemented by one or more arrays, matrices, linked lists, databases, etc., or any combination thereof.

In the illustrated example, the sharpening strength circuitry 220 queries or otherwise accesses a given 2D reference sharpening strength LUT 130 based on the local brightness parameter B_{xy} and the local contrast parameter C_{xy} computed for a pixel at a given location (x,y) of the original input image 165 to retrieve or otherwise obtain one or more reference sharpening strength parameters that map to the combination of the local brightness parameter B_{xy} and the local contrast parameter C_{xy}. For example, if the local brightness parameter B_{xy} and the local contrast parameter C_{xy} computed for the pixel given location (x,y) match a local brightness index and a local contrast index of the 2D reference sharpening strength LUT 130, the sharpening strength circuitry 220 uses the reference sharpening strength parameter mapped in the LUT to those index values as the sharpening strength parameter s(B_{xy}, C_{xy}) for that given pixel.

However, if the local brightness parameter B_{xy} and/or the local contrast parameter C_{xy} computed for the pixel given location (x,y) do not match corresponding local brightness and/or local contrast indices of the 2D reference sharpening strength LUT 130, the sharpening strength circuitry 220 uses interpolation, such as bilinear interpolation, to compute the sharpening strength parameter s(B_{xy}, C_{xy}) for the given pixel based on two (or more) reference sharpening strength parameters retrieved or otherwise obtained from the LUT. For example, the sharpening strength circuitry 220 can retrieve a first reference sharpening strength parameter from the LUT 130 for a first combination of local brightness and local contrast index values that are less than the local brightness parameter B_{xy} and the local contrast parameter C_{xy}, respectively, computed for the given pixel location (x,y), and can retrieve a second reference sharpening strength parameter from the LUT 130 for a second combination of local brightness and local contrast index values that are greater than the local brightness parameter B_{xy} and the local contrast parameter C_{xy}, respectively, computed for the given pixel location (x,y). In such an example, the sharpening strength circuitry 220 can then interpolate between the first and second reference sharpening strength parameters retrieved from the LUT 130 to compute the sharpening strength parameter s(B_{xy}, C_{xy}) for the given pixel location (x,y).

In some examples, the sharpening strength circuitry 220 scales (e.g., multiples) the sharpening strength parameter s(B_{xy}, C_{xy}) computed from the 2D reference sharpening strength LUT 130 by a scale factor to determine a final sharpening strength parameter s(B_{xy}, C_{xy}) to be used for the given pixel at the location (x,y). In some examples the scale factor is programmed by the display engine driver 135 based on user input. For example, if the sharpening strength parameter computed from the 2D reference sharpening strength LUT 130 is denoted by s₁(B_{xy}, C_{xy}) and the scale factor is denoted by s₂, then the sharpening strength circuitry 220 can compute the final sharpening strength parameter s(B_{xy}, C_{xy}) for the given pixel location (x,y) according to Equation 6:

$$s ( {B}_{xy} , {C}_{x y} ) = {s}_{2} \times {s}_{1} ( {B}_{xy} , {C}_{x y} ) \qquad Equation 6$$

As described above, in some examples the 2D reference sharpening strength LUT 130 used by the sharpening strength circuitry 220 is selected based on the particular application 140 be executed by the compute device 105 to generate the input image 165. As described above, in some such examples, the display engine driver 135 of the compute device 105 can request a particular 2D LUT 155 from the server 115 that is tailored or tuned to that particular application 140. In such examples, the display engine driver 135 can then cause the requested 2D LUT 155 to be stored in the display engine circuitry 125 as the 2D LUT 130 that is accessible by the adaptive image sharpening circuitry 110. In some examples, the display engine driver 135 can request multiple different 2D LUTs 155 tailored to multiple different applications 140 from the server 115 during an initialization operation (e.g., at boot-up) and then download the multiple different 2D LUTs 155 to the display engine circuitry 125 for storage as a library of the 2D LUTs 130. In such examples, the display engine driver 135 can instruct the display engine circuitry 125 to activate a particular one of the 2D LUTs 130 from the stored library based on the particular application 140 being executed. Further details concerning the 2D reference sharpening strength LUT(s) 130 are provided below.

The image sharpening circuitry 225 of the illustrated example implements the algorithm of Equation 3 above to generate the sharpened output image 170 corresponding to the original input image 165. As such, in the illustrated example, the image sharpening circuitry 225 computes the difference between the luminance component (Y) of the original input image 165 and the blurred image 230 determined by the unsharp image filter circuitry to compute the difference image, original(x, y)−blurred(x, y), of Equation 3. The image sharpening circuitry 225 then multiplies the respective luminance pixel values of that difference image by the corresponding sharpening strength parameters s(B_{xy}, C_{xy}) computed by the sharpening strength circuitry 220 to determine the resulting scale difference image, (original(x, y)−blurred (x, y))×s(B_{xy}, C_{xy}), of Equation 3. Then image sharpening circuitry 225 then adds that scale difference image to the luminance component (Y) of the original input image 165 to obtain the luminance component (Y) of the sharpened output image 170, which corresponds to the sharpened image sharpened(x, y) of Equation 3. Finally, the image sharpening circuitry 225 combines the luminance component (Y) of the sharpened output image 170 with the chrominance components (UV/CbCr) of the original input image 165 to generate the overall sharpened output image 170. In some examples, the image sharpening circuitry 225 also converts the sharpened output image 170 from YUV/YCbCr format to RGB format.

In some examples, the image sharpening circuitry 225 clips the luminance component (Y) of the sharpened output image 170, which corresponds to sharpened(x, y) of Equation 3, based on a programmable range of output luminance values. In some examples, the programmable range of output luminance values is based on one or more threshold values that may be programmed or otherwise configured by the display engine driver 135. For example, the display engine driver 135 may program the image sharpening circuitry 225 with a relative maximum luminance threshold, denoted as “ProgrammableRelMaxLuma” and a relative maximum luminance threshold, denoted as “ProgrammableRelMinLuma,” either or both of which may be based on user input, tailored to a particular application 140, etc., or any combination thereof. In the illustrated example, the image sharpening circuitry 225 then computes maximum and minimum luminance thresholds for the sharpened pixel at location (x,y) based on the luminance value of the original input image 165 at that location according to Equations 7 and 8:

$$Max Sharpened Luma = Programmable Rel Max Luma \times InpLuma \qquad Equation 7$$

$$Min Sharpened Luma = Programmable Rel Min Luma \times InpLuma \qquad Equation 8$$

In Equations 7 and 8, the variable “InpLuma” denotes the luminance value of pixel at location (x,y) of the original input image 165, the variable “MaxSharpenedLuma” denotes the maximum luminance threshold for that pixel, and the variable “MinSharpenedLuma” denotes the minimum luminance threshold for that pixel.

In the illustrated example, the image sharpening circuitry 225 then clips the luminance component of the pixel at location (x,y) of the sharpened output image 170 according to Equation 9:

$$SharpenedLuma = max ( min ( SharpenedLuma , \\ Max SharpenedLuma ) , MinSharpenedLuma ) \qquad Equation 9$$

In Equation 9, the variable “SharpenedLuma” denotes the luminance component of the pixel at location (x,y) of the sharpened output image 170. As shown in Equation 9, the image sharpening circuitry 225 compares the minimum luminance threshold, MinSharpenedLuma, for the given pixel to the smaller (min) of the maximum luminance threshold, MaxSharpenedLuma, for that given pixel and the sharpened luminance component, SharpenedLuma, computed by the image sharpening circuitry 225 for that given pixel, and then outputs the larger (max) of the two values as the sharpened luminance component for that given pixel.

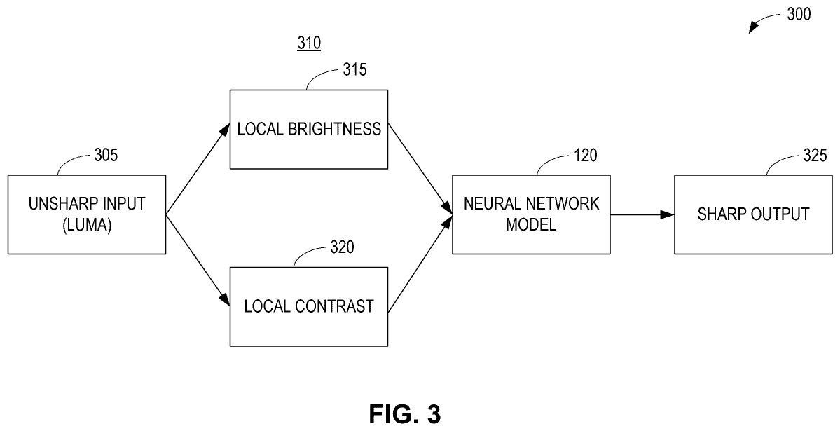

FIG. 3 illustrates an example training procedure 300 implemented by example model training circuitry 145 included in the server 115 of FIG. 1. The example procedure 300 begins with the model training circuitry 145 obtaining an example input training image 305. In the illustrated example, the input training image 305 includes unsharp (e.g., blurred) luminance components corresponding to a ground-truth image. Example procedures for generating the input training image 305 are described above and in further detail below.

In the example procedure 300, the model training circuitry 145 converts the input unsharp training image 305 into an example two-channel input image 310 in which an example first channel 315 contains the local brightness parameters computed by the model training circuitry 145 for the pixels of the training image and an example second channel 320 contains the local contrast parameters computed by the model training circuitry 145 for the pixels of the training image. In the illustrated example, the model training circuitry 145 compute the local brightness and local contrast parameters as described above in connection with the local brightness circuitry 210, the local contrast circuitry 215, and Equations 4-5.

In the example procedure 300, the model training circuitry 145 provides the two-channel input image 310 of local brightness parameters and local contrast parameters to the AI model 120. In the illustrated example, the AI model 120 is implemented by a neural network architecture that accepts the two-channel input image 310 (with one channel being the local brightness and the other channel being the local contrast) determined by the model training circuitry 145 from the respective training image 305, and outputs an example single-channel output image 325 that contains the respective sharpening strength parameters predicted by the AI model 120 for the corresponding pixels of the training image 305. As described in further detail below, the model training circuitry 145 then trains the AI model 120 based on the sharpening strength parameters included in the output image 325 and the ground-truth image corresponding to the input training image 305.

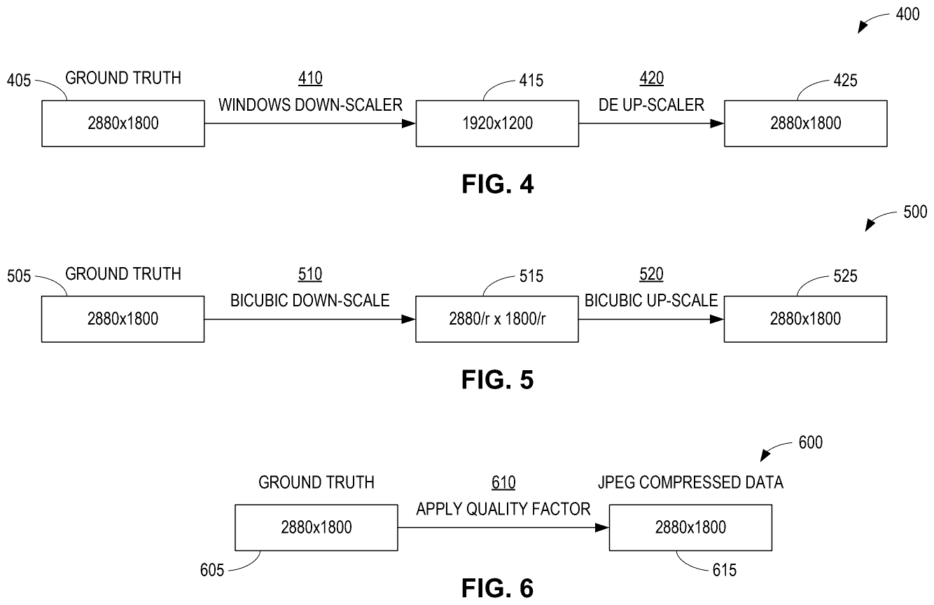

FIGS. 4-6 illustrated example training image generation procedures implemented by the model training circuitry 145 included in the server 115 of FIG. 1. FIG. 4 illustrates an example training image generation procedure 400 capable of generating training data tailored to a use-case (e.g., an application 140) that involves image up-scaling (e.g., image super-resolution). In the example procedure 400, the model training circuitry 145 accesses a collection of ground-truth images 405 (e.g., via the network 160) having 2880×1800 resolution (or some other ground-truth resolution). The model training circuitry 145 performs an example down-scale procedure 410 to down-scale the ground-truth images 405 by a factor of 1.5 (or some other down-scale factor) to generate example down-scaled images 415 having 1920×1200 resolution (or some other down-scaled resolution). For example, the down-scale procedure 410 can be a down-scale procedure provided by Microsoft Windows®.

Next, the model training circuitry 145 performs an example up-scale procedure 420 to up-scale the down-scaled images 415 by a factor of 1.5 (or some other up-scale factor) to generate example training images 425 having 2880×1800 resolution (or some other resolution corresponding to the ground-truth images 405). For example, the up-scale procedure 420 can be an up-scale procedure similar or identical to an up-scale procedure implemented by the display engine circuitry 125 (e.g., based on a particular application 140 associated with up-scaling). The respective pairs of the training images 425 and the corresponding ground-truth images 405 form the training data set for this use-case (e.g., application 140).

FIG. 5 illustrates an example training image generation procedure 500 capable of generating training data tailored to a use-case (e.g., an application 140) that involves a video conference application, such as Microsoft Teams®. In the example procedure 500, the model training circuitry 145 accesses a collection of ground-truth images 505 (e.g., via the network 160) having 2880×1800 resolution (or some other ground-truth resolution). The model training circuitry 145 performs an example bicubic down-scale procedure 510 to down-scale the ground-truth images 505 by a factor of “r” to generate example down-scaled images 515 having 2880/r×1800/r resolution. Next, the model training circuitry 145 performs an example bicubic up-scale procedure 520 to up-scale the down-scaled images 515 by the factor of “r” to generate example training images 525 having 2880×1800 resolution (or some other resolution corresponding to the ground-truth images 505).

In the example procedure 500, 40% of the ground-truth images 505 are down-scaled and then up-scaled using a scale factor of r=1.33, 40% of the ground-truth images 505 are down-scaled and then up-scaled using a scale factor of r=1.6, and the remaining and rest 20% of the ground-truth images 505 are down-scaled and then up-scaled using a scale factor of r=1.7. In an example Teams® call scenario, video frames are downscaled and shared over Internet, and then up-scaled at the receiving compute device for presentation. The foregoing mix of down-scaling and up-scaling factors attempts to simulate a similar scenario, although a different mix of percentages and/or scale factors (r) can be used to simulate other scenarios. The respective pairs of the training images 525 and the corresponding ground-truth images 505 form the training data set for this use-case (e.g., application 140).

FIG. 6 illustrates an example training image generation procedure 600 capable of generating training data tailored to a use-case (e.g., an application 140) that involves lossy image compression, such JPEG compression. In the example procedure 600, the model training circuitry 145 accesses a collection of ground-truth images 605 (e.g., via the network 160) having 2880×1800 resolution (or some other ground-truth resolution). The model training circuitry 145 then applies a JPEG compression procedure 610 to the ground-truth images 605 to generate example training images 615 having 2880×1800 resolution, but with reduced quality based on a quality factor of the JPEG compression procedure 610. For example, the JPEG quality factor can be 50%, or some other value, to generate artifacts in the training images 615. The respective pairs of the training images 615 and the corresponding ground-truth images 605 form the training data set for this use-case (e.g., application 140).

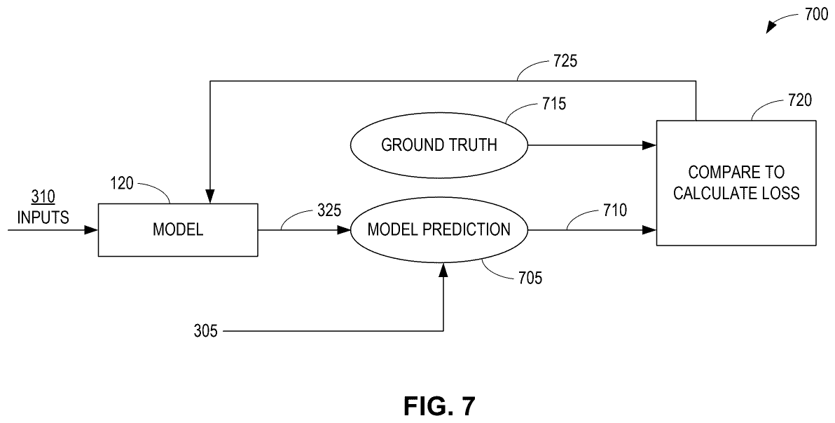

FIG. 7 illustrates an example loss calculation procedure 700 implemented by the model training circuitry 145 included in the server 115 of FIG. 1. In the example procedure 700, the model training circuitry 145 provides the two-channel input image 310 of local brightness parameters and local contrast parameters determined for the input training image 305 to the AI model 120, as described above. As also described above, the AI model 120 outputs the single-channel output image 325 that contains the respective sharpening strength parameters predicted by the AI model 120 for the corresponding pixels of the training image 305. Next, the model training circuitry 145 implements an example model prediction procedure 705 that implements Equation 3 described above to generate an example sharpened output image 710 corresponding to the input training image 305 based on the sharpening strength parameters 325 output from the AI model 120.

In the example procedure 700, the model training circuitry 145 next performs an example loss calculation procedure 720 to compute a loss function that quantifies the difference between the sharpened output image 710 and the ground-truth image 715 corresponding to the input training image 305. In the illustrated example, the loss calculation procedure 720 implemented by the model training circuitry 145 includes evaluating a mean-squared error (MSE) loss between the sharpened output image 710 and the ground-truth image 715, a mean absolute error (MAE) loss between the sharpened output image 710 and the ground-truth image 715, and a perceptual loss between the sharpened output image 710 and the ground-truth image 715. In some examples, a pre-trained model, such as a pre-trained VGG-19 model, is used by the model training circuitry 145 to extract features from both the sharpened output image 710 and the ground-truth image 715 to calculate feature vector distance used compute the perceptual loss. In the illustrated example, the MSE loss, MAE loss and perceptual loss are based on the luminance (Y) channels of the sharpened output image 710 and the ground-truth image 715, and the chrominance (UV) channels are ignored.

In the example procedure 700, the loss function evaluated by the loss calculation procedure 720 is given by Equation 10:

$$Total loss = alpha * MSE\_loss + ( 1 - alpha ) * MAE\_Loss + beta * Perceptual\_loss \qquad Equation 10$$

In Equation 10, the variable “MSE_loss” denotes the MSE loss, the variable “MAE loss” denotes the MAE loss, the variable “Perceptual_loss” denotes the perceptual loss, and the parameters “alpha” and “beta” are weights used to combine the component loss values. In some examples, the alpha and beta weights can take on values in the range from zero (0) to one (1).

Returning to FIG. 1, the LUT generation circuitry 150 of the server 115 uses the AI model 120 model to generate a 2D reference sharpening strength LUT 155, or any other data structure, that maps combinations of local contrast and local brightness index values to corresponding reference sharpening strength parameters provided by the AI model 120 model. In some examples, to generate a given reference sharpening strength LUT 155 based on a given trained AI model 120, the LUT generation circuitry 150 generates a sequence of brightness index values over a range of possible brightness values. For example, the LUT generation circuitry 150 can generate a sequence of 33 brightness index values (or some other number of index values) that are sampled uniformly over a range of 0 to 255, or some other range based on the number of bits used to represent the image pixels. Likewise, the LUT generation circuitry 150 generates a sequence of contrast index values over a range of possible contrast values. For example, the LUT generation circuitry 150 can generate a sequence of 33 contrast index values (or some other number of index values) that are sampled uniformly over a range of 0 to 255, or some other range based on the number of bits used to represent the image pixels.

Next, the LUT generation circuitry 150 generates a synthetic input pattern based on combinations of ones of the brightness index values and ones of the contrast index values. For example, the LUT generation circuitry 150 can generate the synthetic input pattern as a 33×33 input image with two (2) channels in which the first channel has the sequence of 33 brightness index values repeated across each row and the second channel has the sequence of 33 contrast index values repeated down each column. Next, the LUT generation circuitry 150 provides this synthetic input pattern (e.g., synthetic 2-channel image) to the AI model 120, which outputs a single channel output image that includes the reference sharpness strength parameters for combinations of brightness and contrast index values in the synthetic input pattern. This output image of the AI model 120 constitutes the 2D reference sharpening strength LUT 155. As described above, the LUT generation circuitry 155 can be downloaded to the compute device 105 and used as a 2D reference sharpening strength LUT 130 in the display engine circuitry 125.

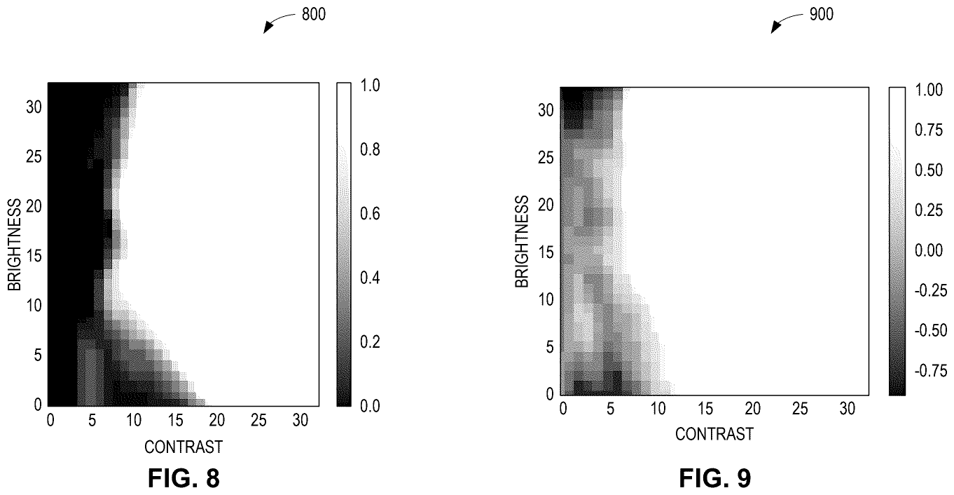

FIGS. 8-9 illustrate example LUTs 800 and 900 of reference sharpening strength parameters generated by the LUT generation circuitry 155 included in the server 115 of FIG. 1 and deployable to the compute device 105 of FIG. 1 for use by the adaptive image sharpening circuitry 110. As such, the LUTs 800 and 900 represent examples of the 2D reference sharpening strength LUT 130 and the 2D reference sharpening strength LUT 155. The LUTs 800 and 900 correspond to different training data sets. In the illustrated examples, the LUTs 800 and 900 are 2D LUTs that are indexed by brightness index values along a first dimension and indexed by contrast index values along a second dimension. In the illustrated examples, the sharpening strength parameters stored in the LUTs 800 and 900 range from a value of zero (0), represented as the color white, and a value of one (1), represented as the color black. Sharpening strength parameter values corresponding to intermediate colors between white and black are indicated in the vertical legends to the right of the LUTs 800 and 900.

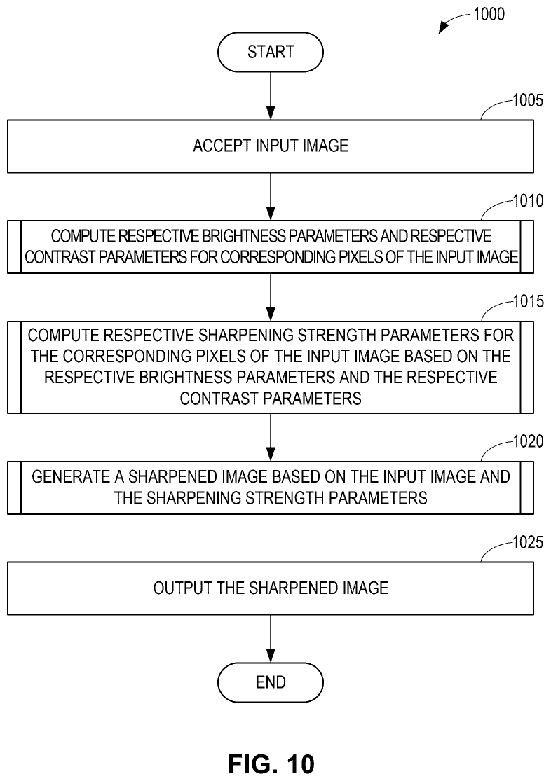

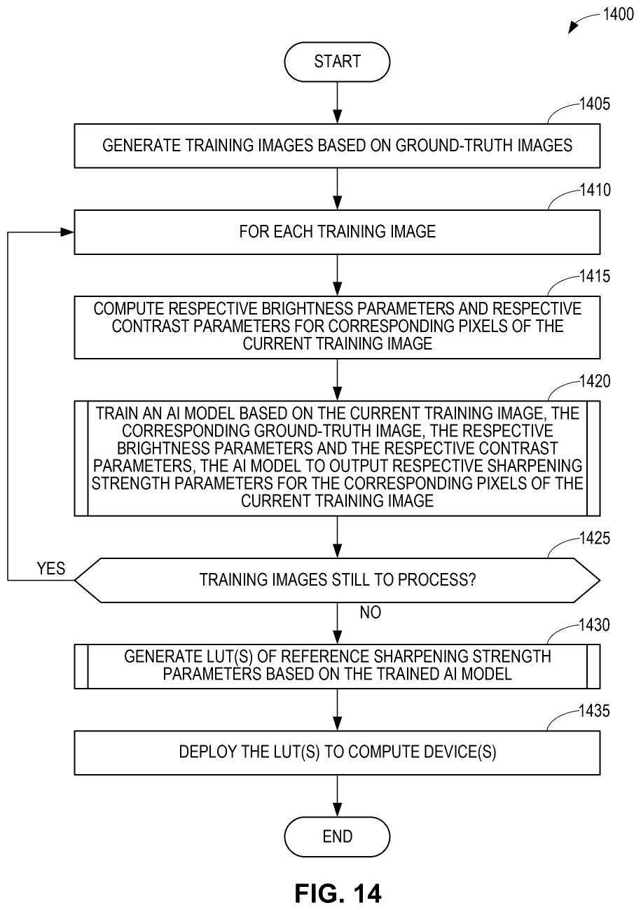

In some examples, the adaptive image sharpening circuitry 110 is instantiated by programmable circuitry executing adaptive image sharpening instructions and/or configured to perform operations such as those represented by the flowchart(s) of FIGS. 10-13. In some examples, the model training circuitry 145 is instantiated by programmable circuitry executing model training instructions and/or configured to perform operations such as those represented by the flowchart(s) of FIGS. 14 and/or 15. In some examples, the LUT generation circuitry 150 is instantiated by programmable circuitry executing LUT generation instructions and/or configured to perform operations such as those represented by the flowchart(s) of FIGS. 14 and/or 16.

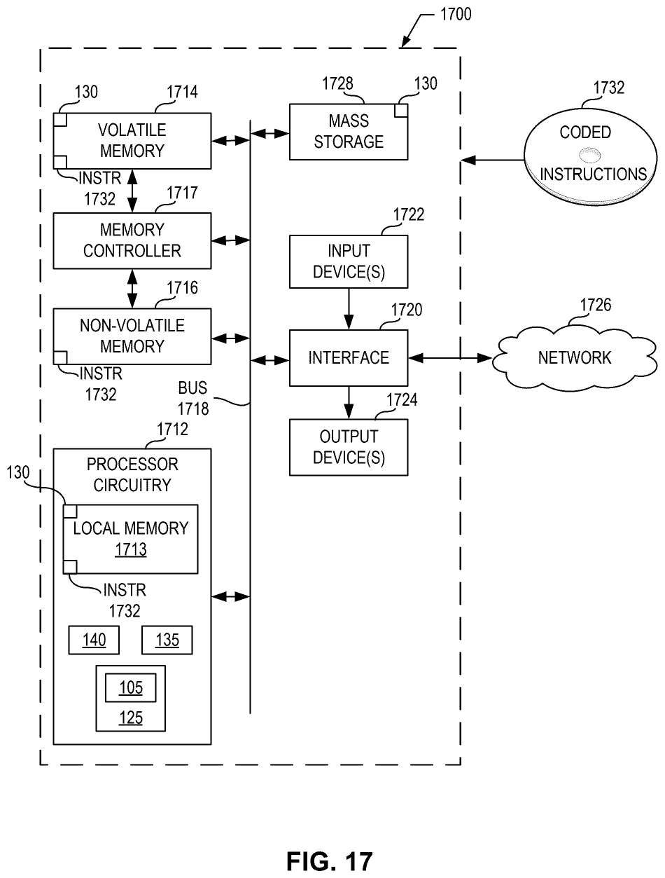

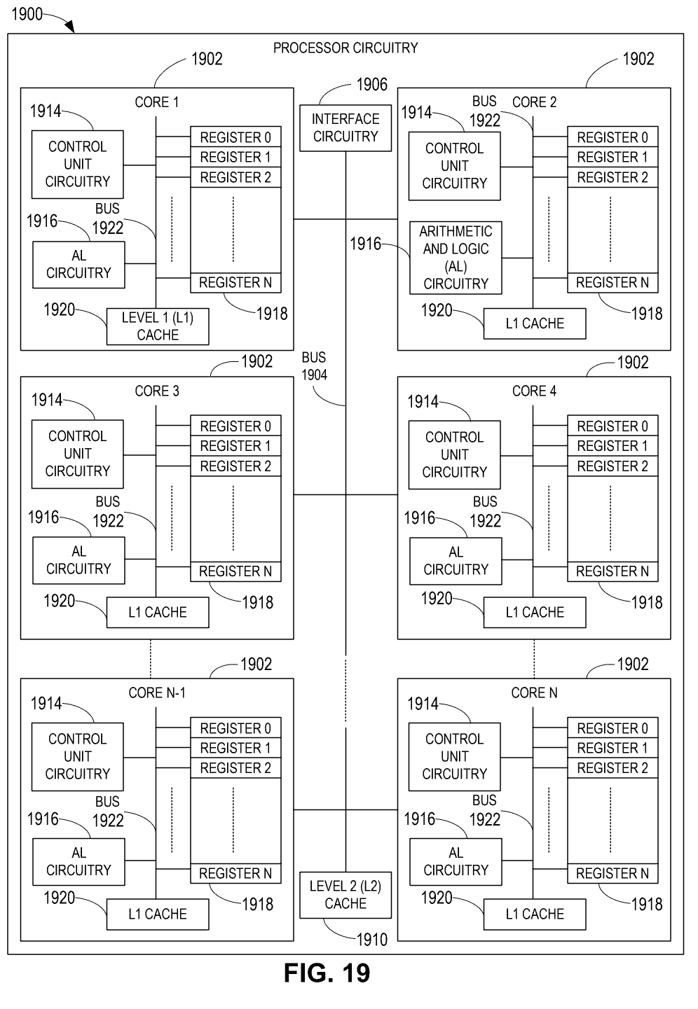

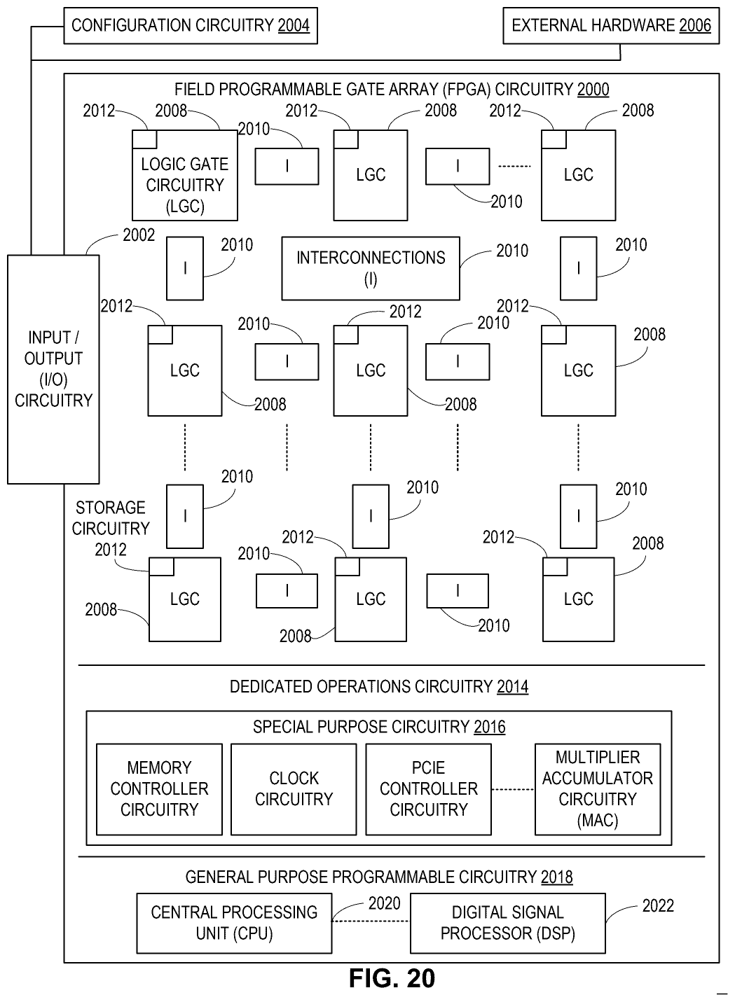

In some examples, the compute device 105 includes means for performing adaptive image sharpening. For example, the means for performing adaptive image sharpening may be implemented by the adaptive image sharpening circuitry 110. In some examples, the adaptive image sharpening circuitry 110 may be instantiated by programmable circuitry such as the example programmable circuitry 1712 of FIG. 17. For instance, the adaptive image sharpening circuitry 110 may be instantiated by the example microprocessor 1900 of FIG. 19 executing machine executable instructions such as those implemented by one or more of the blocks of FIGS. 10-13. In some examples, the adaptive image sharpening circuitry 110 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the adaptive image sharpening circuitry 110 may be instantiated by any other combination of hardware, software, and/or firmware. For example, the adaptive image sharpening circuitry 110 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

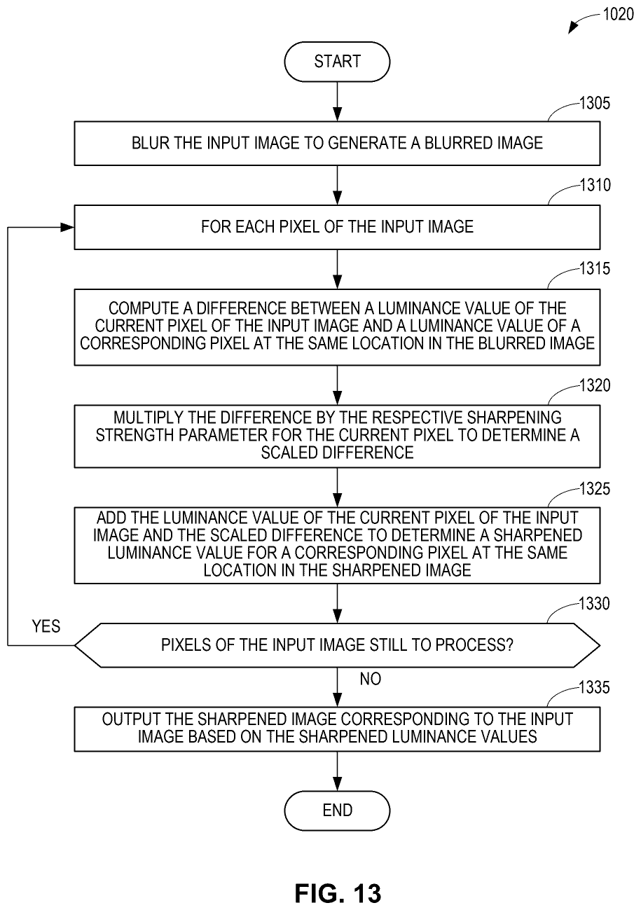

In some examples, the adaptive image sharpening circuitry 110 includes means for performing unsharp image filtering. For example, the means for performing unsharp image filtering may be implemented by the unsharp image filter circuitry 205. In some examples, the unsharp image filter circuitry 205 may be instantiated by programmable circuitry such as the example programmable circuitry 1712 of FIG. 17. For instance, the unsharp image filter circuitry 205 may be instantiated by the example microprocessor 1900 of FIG. 19 executing machine executable instructions such as those implemented by at least block 1305 of FIG. 13. In some examples, the unsharp image filter circuitry 205 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the unsharp image filter circuitry 205 may be instantiated by any other combination of hardware, software, and/or firmware. For example, the unsharp image filter circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

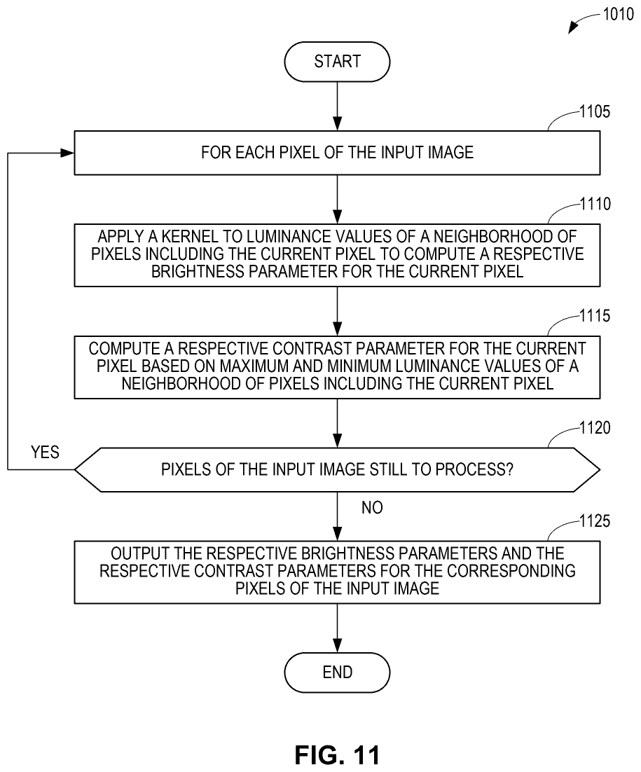

In some examples, the adaptive image sharpening circuitry 110 includes means for computing local brightness parameters. For example, the means for computing local brightness parameters may be implemented by the local brightness circuitry 210. In some examples, the local brightness circuitry 210 may be instantiated by programmable circuitry such as the example programmable circuitry 1712 of FIG. 17. For instance, the local brightness circuitry 210 may be instantiated by the example microprocessor 1900 of FIG. 19 executing machine executable instructions such as those implemented by at least block 1010 of FIG. 10, and/or blocks 1105, 1110, 1120 and/or 1125 of FIG. 11. In some examples, the local brightness circuitry 210 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the local brightness circuitry 210 may be instantiated by any other combination of hardware, software, and/or firmware. For example, the local brightness circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the adaptive image sharpening circuitry 110 includes means for computing local contrast parameters. For example, the means for computing local contrast parameters may be implemented by the local contrast circuitry 215. In some examples, the local contrast circuitry 215 may be instantiated by programmable circuitry such as the example programmable circuitry 1712 of FIG. 17. For instance, the local contrast circuitry 215 may be instantiated by the example microprocessor 1900 of FIG. 19 executing machine executable instructions such as those implemented by at least block 1010 of FIG. 10, and/or blocks 1105, 1115, 1120 and/or 1125 of FIG. 11. In some examples, the local contrast circuitry 215 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the local contrast circuitry 215 may be instantiated by any other combination of hardware, software, and/or firmware. For example, the local contrast circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

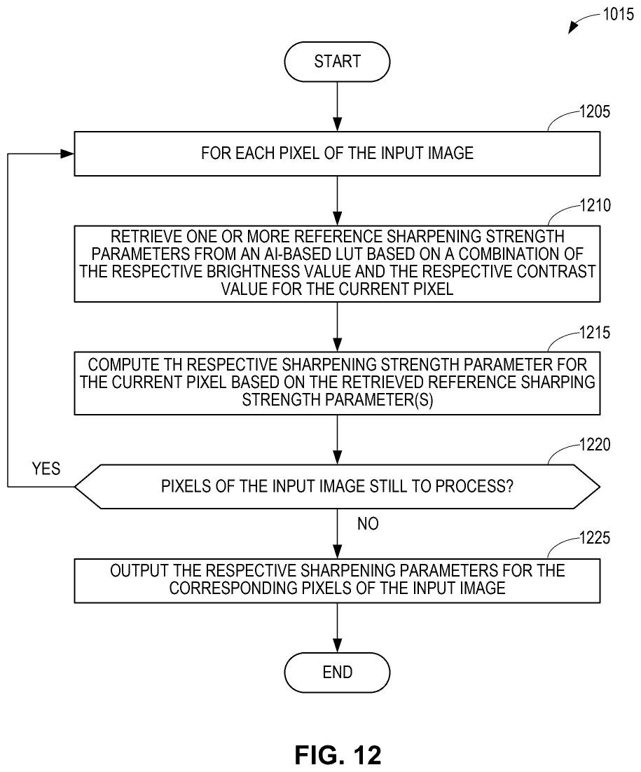

In some examples, the adaptive image sharpening circuitry 110 includes means for computing sharpening strength parameters. For example, the means for sharpening strength parameters may be implemented by the sharpening strength circuitry 220. In some examples, the sharpening strength circuitry 220 may be instantiated by programmable circuitry such as the example programmable circuitry 1712 of FIG. 17. For instance, the sharpening strength circuitry 220 may be instantiated by the example microprocessor 1900 of FIG. 19 executing machine executable instructions such as those implemented by at least block 1015 of FIG. 10, and/or blocks of FIG. 12. In some examples, the sharpening strength circuitry 220 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the sharpening strength circuitry 220 may be instantiated by any other combination of hardware, software, and/or firmware. For example, the sharpening strength circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the adaptive image sharpening circuitry 110 includes means for sharpening images based on sharpening strength parameters. For example, the means for sharpening images based on sharpening strength parameters may be implemented by the image sharpening circuitry 225. In some examples, the image sharpening circuitry 225 may be instantiated by programmable circuitry such as the example programmable circuitry 1712 of FIG. 17. For instance, the image sharpening circuitry 225 may be instantiated by the example microprocessor 1900 of FIG. 19 executing machine executable instructions such as those implemented by at least blocks 1020 and/or 1025 of FIG. 10, and/or blocks 1310-1335 of FIG. 13. In some examples, the image sharpening circuitry 225 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the image sharpening circuitry 225 may be instantiated by any other combination of hardware, software, and/or firmware. For example, the image sharpening circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

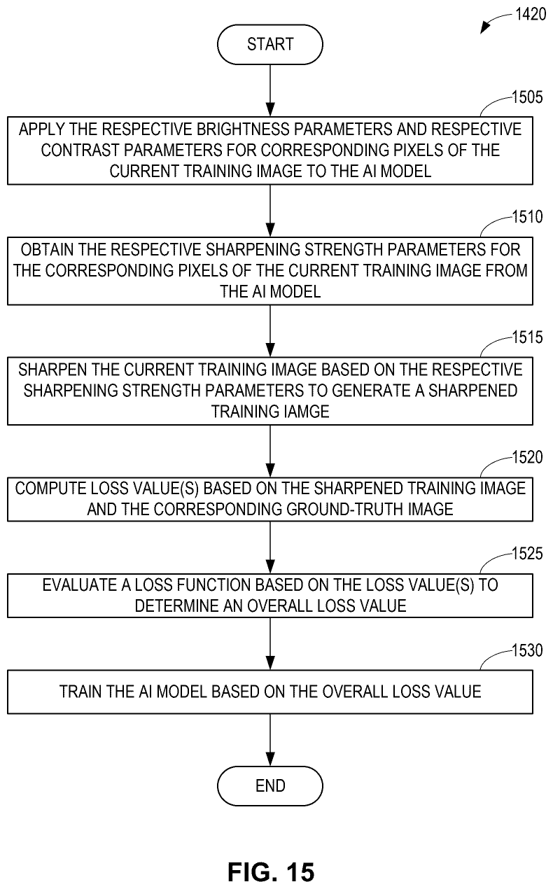

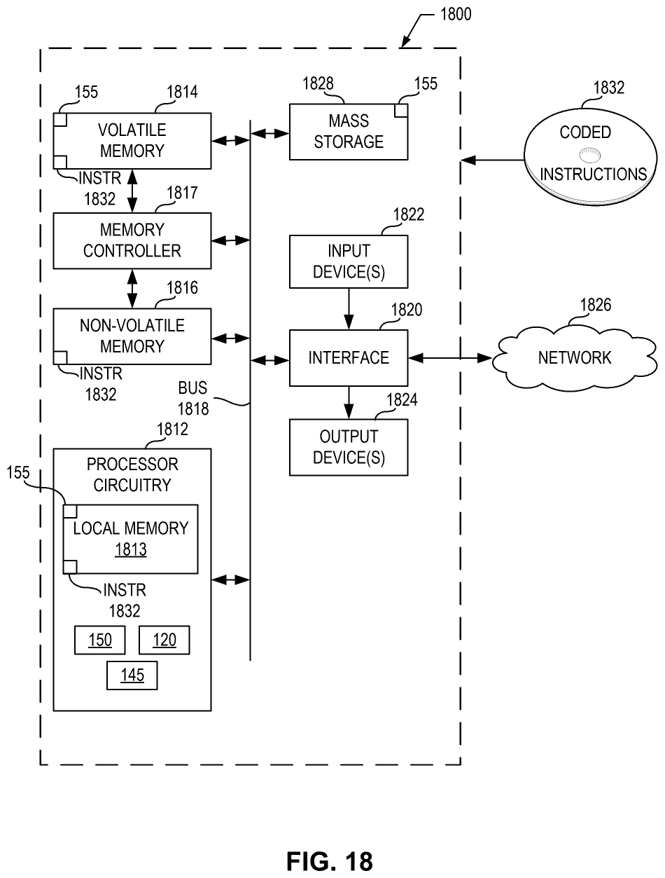

In some examples, the server 115 includes means for performing model training. For example, the means for performing model training may be implemented by the model training circuitry 145. In some examples, the model training circuitry 145 may be instantiated by programmable circuitry such as the example programmable circuitry 1812 of FIG. 18. For instance, the model training circuitry 145 may be instantiated by the example microprocessor 1900 of FIG. 19 executing machine executable instructions such as those implemented by one or more of blocks 1405-1425 of FIG. 14 and/or one or more blocks of FIG. 15. In some examples, the model training circuitry 145 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the model training circuitry 145 may be instantiated by any other combination of hardware, software, and/or firmware. For example, the model training circuitry 145 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

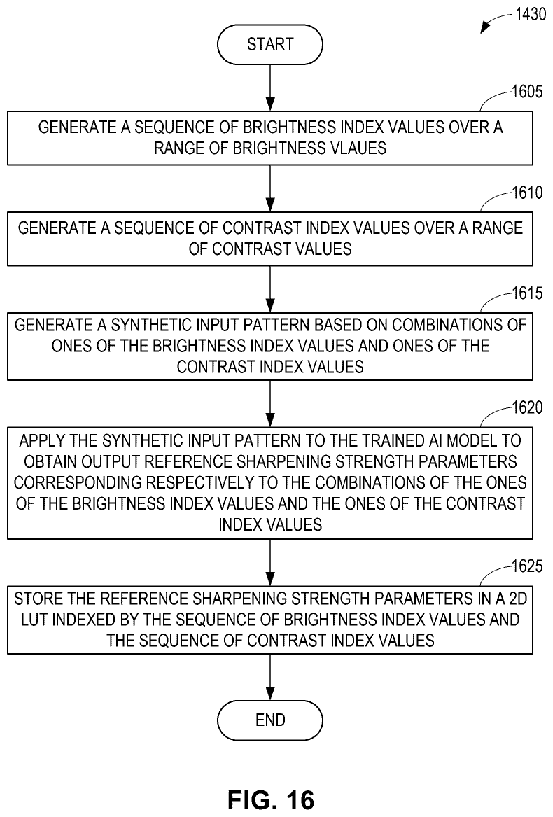

In some examples, the server 115 includes means for generating look-up tables. For example, the means for generating look-up tables may be implemented by the LUT generation circuitry 150. In some examples, the LUT generation circuitry 150 may be instantiated by programmable circuitry such as the example programmable circuitry 1812 of FIG. 18. For instance, the LUT generation circuitry 150 may be instantiated by the example microprocessor 1900 of FIG. 19 executing machine executable instructions such as those implemented by one or more of blocks 1430-1435 of FIG. 14 and/or one or more blocks of FIG. 16. In some examples, the LUT generation circuitry 150 may be instantiated by hardware logic circuitry, which may be implemented by an ASIC, XPU, or the FPGA circuitry 2000 of FIG. 20 configured and/or structured to perform operations corresponding to the machine-readable instructions. Additionally or alternatively, the LUT generation circuitry 150 may be instantiated by any other combination of hardware, software, and/or firmware. For example, the LUT generation circuitry 150 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the compute device 105 is illustrated in FIGS. 1-2, one or more of the elements, processes, and/or devices illustrated in FIGS. 1-2 may be combined, divided, re-arranged, omitted, eliminated, and/or implemented in any other way. Further, the example adaptive image sharpening circuitry 110, the example display engine circuitry 125, one or more of the example reference sharpening strength LUTs 130, the example display engine driver 135, one or more of the example applications 140, the example unsharp image filter circuitry 205, the example local brightness circuitry 210, the example local contrast circuitry 215, the example sharpening strength circuitry 220, the example image sharpening circuitry 225, and/or, more generally, the example compute device 105 of FIGS. 1-2, may be implemented by hardware alone or by hardware in combination with software and/or firmware. Thus, for example, any of the example adaptive image sharpening circuitry 110, the example display engine circuitry 125, one or more of the example reference sharpening strength LUTs 130, the example display engine driver 135, one or more of the example applications 140, the example unsharp image filter circuitry 205, the example local brightness circuitry 210, the example local contrast circuitry 215, the example sharpening strength circuitry 220, the example image sharpening circuitry 225, and/or, more generally, the example compute device 105, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example compute device 105 may include one or more elements, processes, and/or devices in addition to, or instead of, those illustrated in FIGS. 1-2, and/or may include more than one of any or all of the illustrated elements, processes and devices.

While an example manner of implementing the server 115 is illustrated in FIG. 1, one or more of the elements, processes, and/or devices illustrated in FIG. 1 may be combined, divided, re-arranged, omitted, eliminated, and/or implemented in any other way. Further, the example AI model 120, the example model training circuitry 145, the example LUT generation circuitry 150, one or more of the example reference sharpening strength LUTs 155, and/or, more generally, the example server 115 of FIG. 1, may be implemented by hardware alone or by hardware in combination with software and/or firmware. Thus, for example, any of the example AI model 120, the example model training circuitry 145, the example LUT generation circuitry 150, one or more of the example reference sharpening strength LUTs 155, and/or, more generally, the example server 115, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example server 115 may include one or more elements, processes, and/or devices in addition to, or instead of, those illustrated in FIG. 1, and/or may include more than one of any or all of the illustrated elements, processes and devices.

Flowchart(s) representative of example machine-readable instructions, which may be executed by programmable circuitry to implement and/or instantiate the compute device 105 of FIGS. 1-2 and/or the server 115 of FIG. 1, and/or representative of example operations which may be performed by programmable circuitry to implement and/or instantiate the compute device 105 of FIGS. 1-2 and/or the server 115 of FIG. 1, are shown in FIGS. 10-16. The machine-readable instructions may be one or more executable programs or portion(s) of one or more executable programs for execution by programmable circuitry such as the programmable circuitry 1712 shown in the example processor platform 1700 discussed below in connection with FIG. 17, the programmable circuitry 1812 shown in the example processor platform 1800 discussed below in connection with FIG. 18, and/or may be one or more function(s) or portion(s) of functions to be performed by the example programmable circuitry (e.g., an FPGA) discussed below in connection with FIGS. 19 and/or 20. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 10-16, many other methods of implementing the example compute device 105 and/or the server 115 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 10-16 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 10 is a flowchart representative of example machine-readable instructions and/or example operations 1000 that may be executed, instantiated, and/or performed by programmable circuitry to implement the adaptive image sharpening circuitry 110 of FIGS. 1-2. The example machine-readable instructions and/or the example operations 1000 of FIG. 10 begin at block 1005, at which the adaptive image sharpening circuitry 110 accepts the original input image 165 to be sharpened, as described above. At block 1010, the local brightness circuitry 210 and the local contrast circuitry 215 of the adaptive image sharpening circuitry 110 compute respective brightness parameters B_{xy} and respective contrast parameters C_{xy} for corresponding pixels of the input image 165, as described above. At block 1015, the sharpening strength circuitry 220 of the adaptive image sharpening circuitry 110 computes respective sharpening strength parameters s(B_{xy}, C_{xy}) for the corresponding pixels of the input image 165 based on the respective brightness parameters B_{xy} and the respective contrast parameters C_{xy}, as described above. At block 1020, the image sharpening circuitry 225 of the adaptive image sharpening circuitry 110 generates a sharpened image 170 based on the input image 165 and the sharpening strength parameters s(B_{xy}, C_{xy}), as describe above. At block 1025, the image sharpening circuitry 225 outputs the sharpening image 170, as described above. The example machine-readable instructions and/or the example operations 1000 then end.

FIG. 11 is a flowchart representative of example machine-readable instructions and/or example operations 1010 that may be executed, instantiated, and/or performed by programmable circuitry to perform the processing at block 1010 of FIG. 10 and, thus, implement the adaptive image sharpening circuitry 110 of FIGS. 1-2. The example machine-readable instructions and/or the example operations 1000 of FIG. 10 begin at block 1105, at which the local brightness circuitry 210 and the local contrast circuitry 215 of the adaptive image sharpening circuitry 110 begin iterating over the pixels of the input image 165. At block 1110, the local brightness circuitry 210 applies a kernel to luminance values of a neighborhood of pixels including the current pixel to compute a respective brightness parameter B_{xy} for the current pixel, as described above. At block 1115, the local contrast circuitry 215 computes a respective contrast parameter C_{xy} for the current pixel based on maximum and minimum luminance values of a neighborhood of pixels including the current pixel, as described above. At block 1120, the local brightness circuitry 210 and the local contrast circuitry 215 continue iterating over the pixels of the input image 165. If there are remaining pixels to process (corresponding to the YES output of block 1120), processing returns to block 1105 and blocks subsequent thereto. However, if there are no remaining pixels to process (corresponding to the NO output of block 1120), at block 1125 the local brightness circuitry 210 and the local contrast circuitry 215 output the respective brightness parameters B_{xy} and the respective contrast parameters C_{xy} for the corresponding pixels of the input image, as described above. The example machine-readable instructions and/or the example operations 1010 then end.

FIG. 12 is a flowchart representative of example machine-readable instructions and/or example operations 1015 that may be executed, instantiated, and/or performed by programmable circuitry to perform the processing at block 1015 of FIG. 10 and, thus, implement the adaptive image sharpening circuitry 110 of FIGS. 1-2. The example machine-readable instructions and/or the example operations 1015 of FIG. 10 begin at block 1205, at which the sharpening strength circuitry 220 of the adaptive image sharpening circuitry 110 begins iterating over the pixels of the input image 165. At block 1210, the sharpening strength circuitry 220 retrieves one or more reference sharpening strength parameters from the AI-based LUT 130 based on a combination of the respective brightness value B_{xy} and the respective contrast value C_{xy} for the current pixel, as described above. At block 1215, the sharpening strength circuitry 220 computes the respective sharpening strength parameter s(B_{xy}, C_{xy}) for the current pixel based on the retrieved reference sharpening strength parameter(s) (e.g., based on interpolation, scaling, etc.), as described above. At block 1220, the sharpening strength circuitry 220 continues iterating over the pixels of the input image 165. If there are remaining pixels to process (corresponding to the YES output of block 1220), processing returns to block 1205 and blocks subsequent thereto. However, if there are no remaining pixels to process (corresponding to the NO output of block 1220), at block 1225 the sharpening strength circuitry 220 outputs the respective sharpening strength parameters s(B_{xy}, C_{xy}) for the corresponding pixels of the input image, as described above. The example machine-readable instructions and/or the example operations 1010 then end.

FIG. 13 is a flowchart representative of example machine-readable instructions and/or example operations 1020 that may be executed, instantiated, and/or performed by programmable circuitry to perform the processing at block 1020 of FIG. 10 and, thus, implement the adaptive image sharpening circuitry 110 of FIGS. 1-2. The example machine-readable instructions and/or the example operations 1020 of FIG. 10 begin at block 1305, at which the unsharp image filter circuitry 205 of the adaptive image sharpening circuitry 110 blurs the input image 165 to generate the blurred image 230, as described above. At block 1310, the image sharpening circuitry 225 of the adaptive image sharpening circuitry 110 begins iterating over the pixels of the input image 165. At block 1315, the image sharpening circuitry 225 computes a difference between a luminance value of the current pixel of the input image 165 and a luminance value of a corresponding pixel at the same location in the blurred image 230, which corresponds to original(x, y)−blurred(x, y) of Equation 3, as described above.

At block 1320, the image sharpening circuitry 225 multiply the difference determined at block 1315 by the respective sharpening strength parameter for the current pixel to determine a scaled difference, which corresponds to (original(x, y)−blurred(x, y))×s(B_{xy}, C_{xy}) of Equation 3, as described above. At block 1325, the image sharpening circuitry 225 adds the luminance value of the current pixel of the input image 165 and the scaled difference determined at block 1320 to determine a sharpened luminance value for a corresponding pixel at the same location in the sharpened image 170, which corresponds to sharpened(x, y) of Equation 3, as described above. At block 1330, the image sharpening circuitry 225 continues iterating over the pixels of the input image 165. If there are remaining pixels to process (corresponding to the YES output of block 1330), processing returns to block 1305 and blocks subsequent thereto. However, if there are no remaining pixels to process (corresponding to the NO output of block 1320), at block 1335 the image sharpening circuitry 225 outputs the sharpened image 170 corresponding to the input image 165 based on the sharpened luminance values, as described above. The example machine-readable instructions and/or the example operations 1020 then end.

FIG. 14 is a flowchart representative of example machine-readable instructions and/or example operations 1400 that may be executed, instantiated, and/or performed by programmable circuitry to implement the model training circuitry 145 and the LUT generation circuitry 150 of FIG. 1. The example machine-readable instructions and/or the example operations 1400 of FIG. 14 begin at block 1405, at which the model training circuitry 145 generates training images based on ground-truth images, as described above. At block 1410, the model training circuitry 145 begins iterating over the training images. At block 1415, the model training circuitry 145 computes respective brightness parameters and respective contrast parameters for corresponding pixels of the current training image, as described above. At block 1420, the model training circuitry 145 trains the AI model 120 based on the current training image, the corresponding ground-truth image, the respective brightness parameters and the respective contrast parameters to output respective sharpening strength parameters for the corresponding pixels of the current training image, as described above.

At block 1425, the model training circuitry 145 continues iterating over the pixels of the input image 165. If there are remaining training images to process (corresponding to the YES output of block 1425), processing returns to block 1405 and blocks subsequent thereto. However, if there are no remaining training images to process (corresponding to the NO output of block 1425), at block 1430 the LUT generation circuitry 150 generates LUT(s) 155 of reference sharpening strength parameters based on the trained AI model 120, as described above. At block 1435, the LUT generation circuitry 150 deploys the LUT(s) 155 to the compute device 105 (and any other compute devices), as described above. The example machine-readable instructions and/or the example operations 1400 then end.

FIG. 15 is a flowchart representative of example machine-readable instructions and/or example operations 1420 that may be executed, instantiated, and/or performed by programmable circuitry to perform the processing at block 1420 of FIG. 14 and, thus, implement the model training circuitry 145 of FIG. 1. The example machine-readable instructions and/or the example operations 1420 of FIG. 15 begin at block 1505, at which the model training circuitry 145 applies the respective brightness parameters and the respective contrast parameters computed for the corresponding pixels of the current training image to the AI model 120, as described above. At block 1610, the model training circuitry 145 obtains the respective sharpening strength parameters for the corresponding pixels of the current training image from the AI model 120, as described above. At block 1515, the model training circuitry 145 sharpens the current training image based on the respective sharpening strength parameters obtained at block 1510 to generate a sharpened training image (e.g., according to Equation 3), as described above. At block 1520, the model training circuitry 145 computes loss value(s) (e.g., such as MSE loss, MAE loss and/or perceptual loss) based on the sharpened training image and the corresponding ground-truth image, as described above. At block 1525, the model training circuitry 145 evaluates a loss function based on the loss value(s) obtained at block 1520 to determine an overall loss value, as described above. At block 1530, the model training circuitry 145 trains the AI model 120 based on the overall loss value obtained at block 1525, as described above. The example machine-readable instructions and/or the example operations 1420 then end.

FIG. 16 is a flowchart representative of example machine-readable instructions and/or example operations 1430 that may be executed, instantiated, and/or performed by programmable circuitry to perform the processing at block 1430 of FIG. 14 and, thus, implement the LUT generation circuitry 150 of FIG. 1. The example machine-readable instructions and/or the example operations 1430 of FIG. 16 begin at block 1605, at which the LUT generation circuitry 150 generates a sequence of brightness index values over a range of brightness values, as described above. At block 1610, the LUT generation circuitry 150 generates a sequence of contrast index values over a range of contrast values, as described above. At block 1615, the LUT generation circuitry 150 generates a synthetic input pattern based on combinations of ones of the brightness index values and ones of the contrast index values, as described above. At block 1620, the LUT generation circuitry 150 applies the synthetic input pattern to the trained AI model 120 to obtain output reference sharpening strength parameters corresponding respectively to the combinations of the ones of the brightness index values and the ones of the contrast index values, as described above. At block 1625, the LUT generation circuitry 150 stores the reference sharpening strength parameters in a 2D LUT, such as the 2D LUT 155, which is indexed by the sequence of brightness index values and the sequence of contrast index values, as described above. The example machine-readable instructions and/or the example operations 1430 then end.

FIG. 17 is a block diagram of an example programmable circuitry platform 1700 structured to execute and/or instantiate the example machine-readable instructions and/or the example operations of FIGS. 10-13 to implement the compute device 105 of FIGS. 1-2. The programmable circuitry platform 1700 can be, for example, a personal computer, a workstation, a server, a self-learning machine (e.g., a neural network), a mobile device (e.g., a cell phone, a smart phone, a tablet such as an iPad™), a personal digital assistant (PDA), an Internet appliance, a DVD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1700 of the illustrated example includes programmable circuitry 1712. The programmable circuitry 1712 of the illustrated example is hardware. For example, the programmable circuitry 1712 can be implemented by one or more integrated circuits, logic circuits, FPGAs, microprocessors, CPUs, GPUs, VPUs, DSPs, and/or microcontrollers from any desired family or manufacturer. The programmable circuitry 1712 may be implemented by one or more semiconductor based (e.g., silicon based) devices. In this example, the programmable circuitry 1712 implements the adaptive image sharpening circuitry 110, the display engine circuitry 125, the display engine driver 135 and/or one or more of the applications 140.

The programmable circuitry 1712 of the illustrated example includes a local memory 1713 (e.g., a cache, registers, etc.). The programmable circuitry 1712 of the illustrated example is in communication with main memory 1714, 1716, which includes a volatile memory 1714 and a non-volatile memory 1716, by a bus 1718. The volatile memory 1714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1716 may be implemented by flash memory and/or any other desired type of memory device. Access to the main memory 1714, 1716 of the illustrated example is controlled by a memory controller 1717. In some examples, the memory controller 1717 may be implemented by one or more integrated circuits, logic circuits, microcontrollers from any desired family or manufacturer, or any other type of circuitry to manage the flow of data going to and from the main memory 1714, 1716. In some examples, the local memory 1713 and/or the main memory 1714, 1716 store one or more of the reference sharpening strength LUTs 130.

The programmable circuitry platform 1700 of the illustrated example also includes interface circuitry 1720. The interface circuitry 1720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1722 are connected to the interface circuitry 1720. The input device(s) 1722 permit(s) a user (e.g., a human user, a machine user, etc.) to enter data and/or commands into the programmable circuitry 1712. The input device(s) 1722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1724 are also connected to the interface circuitry 1720 of the illustrated example. The output device(s) 1724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1720 of the illustrated example, thus, typically includes a graphics driver card, a graphics driver chip, and/or graphics processor circuitry such as a GPU.

The interface circuitry 1720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1700 of the illustrated example also includes one or more mass storage discs or devices 1728 to store firmware, software, and/or data. Examples of such mass storage discs or devices 1728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, the mass storage discs or devices 1728 store one or more of the reference sharpening strength LUTs 130.

The machine-readable instructions 1732, which may be implemented by the machine-readable instructions of FIGS. 10-13, may be stored in the mass storage device 1728, in the volatile memory 1714, in the non-volatile memory 1716, and/or on at least one non-transitory computer-readable storage medium such as a CD or DVD which may be removable.

FIG. 18 is a block diagram of an example programmable circuitry platform 1800 structured to execute and/or instantiate the example machine-readable instructions and/or the example operations of FIGS. 14-16 to implement the server 115 of FIG. 1. The programmable circuitry platform 1800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1800 of the illustrated example includes programmable circuitry 1812. The programmable circuitry 1812 of the illustrated example is hardware. For example, the programmable circuitry 1812 can be implemented by one or more integrated circuits, logic circuits, FPGAs, microprocessors, CPUs, GPUs, VPUs, DSPs, and/or microcontrollers from any desired family or manufacturer. The programmable circuitry 1812 may be implemented by one or more semiconductor based (e.g., silicon based) devices. In this example, the programmable circuitry 1812 implements the AI model 120, the model training circuitry 145, and/or the LUT generation circuitry 150.

The programmable circuitry 1812 of the illustrated example includes a local memory 1813 (e.g., a cache, registers, etc.). The programmable circuitry 1812 of the illustrated example is in communication with main memory 1814, 1816, which includes a volatile memory 1814 and a non-volatile memory 1816, by a bus 1818. The volatile memory 1814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1816 may be implemented by flash memory and/or any other desired type of memory device. Access to the main memory 1814, 1816 of the illustrated example is controlled by a memory controller 1817. In some examples, the memory controller 1817 may be implemented by one or more integrated circuits, logic circuits, microcontrollers from any desired family or manufacturer, or any other type of circuitry to manage the flow of data going to and from the main memory 1814, 1816. In some examples, the local memory 1813 and/or the main memory 1814, 1816 store one or more of the reference sharpening strength LUTs 155.

The programmable circuitry platform 1800 of the illustrated example also includes interface circuitry 1820. The interface circuitry 1820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1822 are connected to the interface circuitry 1820. The input device(s) 1822 permit(s) a user (e.g., a human user, a machine user, etc.) to enter data and/or commands into the programmable circuitry 1812. The input device(s) 1822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1824 are also connected to the interface circuitry 1820 of the illustrated example. The output device(s) 1824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1820 of the illustrated example, thus, typically includes a graphics driver card, a graphics driver chip, and/or graphics processor circuitry such as a GPU.

The interface circuitry 1820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1800 of the illustrated example also includes one or more mass storage discs or devices 1828 to store firmware, software, and/or data. Examples of such mass storage discs or devices 1828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs. In some examples, the mass storage discs or devices 1828 store one or more of the reference sharpening strength LUTs 155.

The machine-readable instructions 1832, which may be implemented by the machine-readable instructions of FIGS. 14-16, may be stored in the mass storage device 1828, in the volatile memory 1814, in the non-volatile memory 1816, and/or on at least one non-transitory computer-readable storage medium such as a CD or DVD which may be removable.

FIG. 19 is a block diagram of an example implementation of the programmable circuitry 1712 of FIG. 17 and/or the programmable circuitry 1812 of FIG. 18. In this example, the programmable circuitry 1712 of FIG. 17 and/or the programmable circuitry 1812 of FIG. 18 is implemented by a microprocessor 1900. For example, the microprocessor 1900 may be a general-purpose microprocessor (e.g., general-purpose microprocessor circuitry). The microprocessor 1900 executes some or all of the machine-readable instructions of the flowcharts of FIGS. 10-16 to effectively instantiate the circuitry of FIGS. 1 and/or 2 as logic circuits to perform operations corresponding to those machine-readable instructions. In some such examples, the circuitry of FIGS. 1 and/or 2 is instantiated by the hardware circuits of the microprocessor 1900 in combination with the machine-readable instructions. For example, the microprocessor 1900 may be implemented by multi-core hardware circuitry such as a CPU, a DSP, a GPU, an XPU, etc. Although it may include any number of example cores 1902 (e.g., 1 core), the microprocessor 1900 of this example is a multi-core semiconductor device including N cores. The cores 1902 of the microprocessor 1900 may operate independently or may cooperate to execute machine-readable instructions. For example, machine code corresponding to a firmware program, an embedded software program, or a software program may be executed by one of the cores 1902 or may be executed by multiple ones of the cores 1902 at the same or different times. In some examples, the machine code corresponding to the firmware program, the embedded software program, or the software program is split into threads and executed in parallel by two or more of the cores 1902. The software program may correspond to a portion or all of the machine-readable instructions and/or operations represented by the flowcharts of FIGS. 10-16.

The cores 1902 may communicate by a first example bus 1904. In some examples, the first bus 1904 may be implemented by a communication bus to effectuate communication associated with one(s) of the cores 1902. For example, the first bus 1904 may be implemented by at least one of an Inter-Integrated Circuit (I2C) bus, a Serial Peripheral Interface (SPI) bus, a PCI bus, or a PCIe bus. Additionally or alternatively, the first bus 1904 may be implemented by any other type of computing or electrical bus. The cores 1902 may obtain data, instructions, and/or signals from one or more external devices by example interface circuitry 1906. The cores 1902 may output data, instructions, and/or signals to the one or more external devices by the interface circuitry 1906. Although the cores 1902 of this example include example local memory 1920 (e.g., Level 1 (L1) cache that may be split into an L1 data cache and an L1 instruction cache), the microprocessor 1900 also includes example shared memory 1910 that may be shared by the cores (e.g., Level 2 (L2 cache)) for high-speed access to data and/or instructions. Data and/or instructions may be transferred (e.g., shared) by writing to and/or reading from the shared memory 1910. The local memory 1920 of each of the cores 1902 and the shared memory 1910 may be part of a hierarchy of storage devices including multiple levels of cache memory and the main memory (e.g., the main memory 1714, 1716 of FIG. 17, the main memory 1814, 1816 of FIG. 18, etc.). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1902 may be referred to as a CPU, DSP, GPU, etc., or any other type of hardware circuitry. Each core 1902 includes control unit circuitry 1914, arithmetic and logic (AL) circuitry (sometimes referred to as an ALU) 1916, a plurality of registers 1918, the local memory 1920, and a second example bus 1922. Other structures may be present. For example, each core 1902 may include vector unit circuitry, single instruction multiple data (SIMD) unit circuitry, load/store unit (LSU) circuitry, branch/jump unit circuitry, floating-point unit (FPU) circuitry, etc. The control unit circuitry 1914 includes semiconductor-based circuits structured to control (e.g., coordinate) data movement within the corresponding core 1902. The AL circuitry 1916 includes semiconductor-based circuits structured to perform one or more mathematic and/or logic operations on the data within the corresponding core 1902. The AL circuitry 1916 of some examples performs integer based operations. In other examples, the AL circuitry 1916 also performs floating-point operations. In yet other examples, the AL circuitry 1916 may include first AL circuitry that performs integer-based operations and second AL circuitry that performs floating-point operations. In some examples, the AL circuitry 1916 may be referred to as an Arithmetic Logic Unit (ALU).

The registers 1918 are semiconductor-based structures to store data and/or instructions such as results of one or more of the operations performed by the AL circuitry 1916 of the corresponding core 1902. For example, the registers 1918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1918 may be arranged in a bank as shown in FIG. 19. Alternatively, the registers 1918 may be organized in any other arrangement, format, or structure, such as by being distributed throughout the core 1902 to shorten access time. The second bus 1922 may be implemented by at least one of an I2C bus, a SPI bus, a PCI bus, or a PCIe bus.

Each core 1902 and/or, more generally, the microprocessor 1900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1900 is a semiconductor device fabricated to include many transistors interconnected to implement the structures described above in one or more integrated circuits (ICs) contained in one or more packages.

The microprocessor 1900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1900, in the same chip package as the microprocessor 1900 and/or in one or more separate packages from the microprocessor 1900.

FIG. 20 is a block diagram of another example implementation of the programmable circuitry 1712 of FIG. 17 and/or the programmable circuitry 1812 of FIG. 18. In this example, the programmable circuitry 1712 and/or the programmable circuitry 1812 of FIG. 18 is implemented by FPGA circuitry 2000. For example, the FPGA circuitry 2000 may be implemented by an FPGA. The FPGA circuitry 2000 can be used, for example, to perform operations that could otherwise be performed by the example microprocessor 1900 of FIG. 19 executing corresponding machine-readable instructions. However, once configured, the FPGA circuitry 2000 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1900 of FIG. 19 described above (which is a general purpose device that may be programmed to execute some or all of the machine-readable instructions represented by the flowchart(s) of FIGS. 10-16 but whose interconnections and logic circuitry are fixed once fabricated), the FPGA circuitry 2000 of the example of FIG. 20 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 10-16. In particular, the FPGA circuitry 2000 may be thought of as an array of logic gates, interconnections, and switches. The switches can be programmed to change how the logic gates are interconnected by the interconnections, effectively forming one or more dedicated logic circuits (unless and until the FPGA circuitry 2000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 10-16. As such, the FPGA circuitry 2000 may be configured and/or structured to effectively instantiate some or all of the operations/functions corresponding to the machine-readable instructions of the flowchart(s) of FIGS. 10-16 as dedicated logic circuits to perform the operations/functions corresponding to those software instructions in a dedicated manner analogous to an ASIC. Therefore, the FPGA circuitry 2000 may perform the operations/functions corresponding to the some or all of the machine-readable instructions of FIGS. 10-16 faster than the general-purpose microprocessor can execute the same.

In the example of FIG. 20, the FPGA circuitry 2000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 2000 of FIG. 20 may access and/or load the binary file to cause the FPGA circuitry 2000 of FIG. 20 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 2000 of FIG. 20 to cause configuration and/or structuring of the FPGA circuitry 2000 of FIG. 20, or portion(s) thereof.

The FPGA circuitry 2000 of FIG. 20, includes example input/output (I/O) circuitry 2002 to obtain and/or output data to/from example configuration circuitry 2004 and/or external hardware 2006. For example, the configuration circuitry 2004 may be implemented by interface circuitry that may obtain a binary file, which may be implemented by a bit stream, data, and/or machine-readable instructions, to configure the FPGA circuitry 2000, or portion(s) thereof. In some such examples, the configuration circuitry 2004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 2006 may be implemented by external hardware circuitry. For example, the external hardware 2006 may be implemented by the microprocessor 1900 of FIG. 19.

The FPGA circuitry 2000 also includes an array of example logic gate circuitry 2008, a plurality of example configurable interconnections 2010, and example storage circuitry 2012. The logic gate circuitry 2008 and the configurable interconnections 2010 are configurable to instantiate one or more operations/functions that may correspond to at least some of the machine-readable instructions of FIGS. 10-16 and/or other desired operations. The logic gate circuitry 2008 shown in FIG. 20 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 2008 to enable configuration of the electrical structures and/or the logic gates to form circuits to perform desired operations/functions. The logic gate circuitry 2008 may include other electrical structures such as look-up tables (LUTs), registers (e.g., flip-flops or latches), multiplexers, etc.

The configurable interconnections 2010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 2008 to program desired logic circuits.

The storage circuitry 2012 of the illustrated example is structured to store result(s) of the one or more of the operations performed by corresponding logic gates. The storage circuitry 2012 may be implemented by registers or the like. In the illustrated example, the storage circuitry 2012 is distributed amongst the logic gate circuitry 2008 to facilitate access and increase execution speed.

The example FPGA circuitry 2000 of FIG. 20 also includes example dedicated operations circuitry 2014. In this example, the dedicated operations circuitry 2014 includes special purpose circuitry 2016 that may be invoked to implement commonly used functions to avoid the need to program those functions in the field. Examples of such special purpose circuitry 2016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 2000 may also include example general purpose programmable circuitry 2018 such as an example CPU 2020 and/or an example DSP 2022. Other general purpose programmable circuitry 2018 may additionally or alternatively be present such as a GPU, an XPU, etc., that can be programmed to perform other operations.

Although FIGS. 19 and 20 illustrate two example implementations of the programmable circuitry 1712 of FIG. 17 and/or the programmable circuitry 1812 of FIG. 18, many other approaches are contemplated. For example, FPGA circuitry may include an on-board CPU, such as one or more of the example CPU 2020 of FIG. 19. Therefore, the programmable circuitry 1712 of FIG. 17 may additionally be implemented by combining at least the example microprocessor 1900 of FIG. 19 and the example FPGA circuitry 2000 of FIG. 20. In some such hybrid examples, one or more cores 1902 of FIG. 19 may execute a first portion of the machine-readable instructions represented by the flowchart(s) of FIGS. 10-16 to perform first operation(s)/function(s), the FPGA circuitry 2000 of FIG. 20 may be configured and/or structured to perform second operation(s)/function(s) corresponding to a second portion of the machine-readable instructions represented by the flowcharts of FIG. 10-16, and/or an ASIC may be configured and/or structured to perform third operation(s)/function(s) corresponding to a third portion of the machine-readable instructions represented by the flowcharts of FIGS. 10-16.

It should be understood that some or all of the circuitry of FIGS. 1 and/or 2 may, thus, be instantiated at the same or different times. For example, same and/or different portion(s) of the microprocessor 1900 of FIG. 19 may be programmed to execute portion(s) of machine-readable instructions at the same and/or different times. In some examples, same and/or different portion(s) of the FPGA circuitry 2000 of FIG. 20 may be configured and/or structured to perform operations/functions corresponding to portion(s) of machine-readable instructions at the same and/or different times.

In some examples, some or all of the circuitry of FIGS. 1 and/or 2 may be instantiated, for example, in one or more threads executing concurrently and/or in series. For example, the microprocessor 1900 of FIG. 19 may execute machine-readable instructions in one or more threads executing concurrently and/or in series. In some examples, the FPGA circuitry 2000 of FIG. 20 may be configured and/or structured to carry out operations/functions concurrently and/or in series. Moreover, in some examples, some or all of the circuitry of FIGS. 1 and/or 2 may be implemented within one or more virtual machines and/or containers executing on the microprocessor 1900 of FIG. 19.

In some examples, the programmable circuitry 1712 of FIG. 17 and/or the programmable circuitry 1812 of FIG. 18 may be in one or more packages. For example, the microprocessor 1900 of FIG. 19 and/or the FPGA circuitry 2000 of FIG. 20 may be in one or more packages. In some examples, an XPU may be implemented by the programmable circuitry 1712 of FIG. 17 and/or the programmable circuitry 1812 of FIG. 18, which may be in one or more packages. For example, the XPU may include a CPU (e.g., the microprocessor 1900 of FIG. 19, the CPU 2020 of FIG. 20, etc.) in one package, a DSP (e.g., the DSP 2022 of FIG. 20) in another package, a GPU in yet another package, and an FPGA (e.g., the FPGA circuitry 2000 of FIG. 20) in still yet another package.

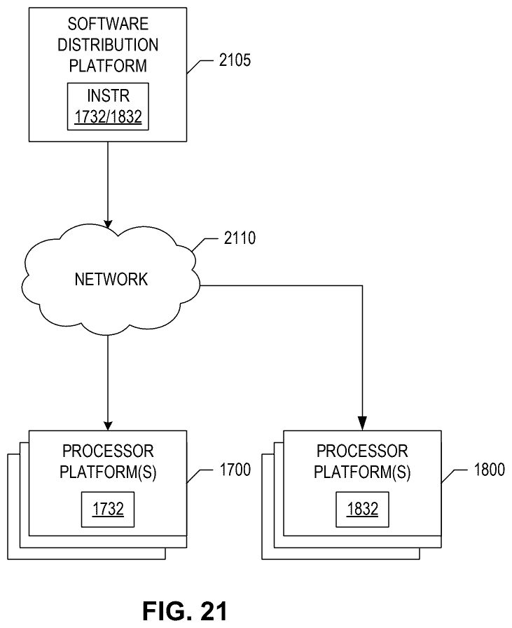

A block diagram illustrating an example software distribution platform 2105 to distribute software such as the example machine-readable instructions 1732 of FIG. 17 and/or the example machine-readable instructions 1832 of FIG. 18 to other hardware devices (e.g., hardware devices owned and/or operated by third parties from the owner and/or operator of the software distribution platform) is illustrated in FIG. 21. The example software distribution platform 2105 may be implemented by any computer server, data facility, cloud service, etc., capable of storing and transmitting software to other computing devices. The third parties may be customers of the entity owning and/or operating the software distribution platform 2105. For example, the entity that owns and/or operates the software distribution platform 2105 may be a developer, a seller, and/or a licensor of software such as the example machine-readable instructions 1732 of FIG. 17 and/or the example machine-readable instructions 1832 of FIG. 18. The third parties may be consumers, users, retailers, OEMs, etc., who purchase and/or license the software for use and/or re-sale and/or sub-licensing. In the illustrated example, the software distribution platform 2105 includes one or more servers and one or more storage devices. The storage devices store the machine-readable instructions 1732, which may correspond to the example machine-readable instructions of FIGS. 10-13, as described above. The storage devices store the machine-readable instructions 1832, which may correspond to the example machine-readable instructions of FIGS. 14-16, as described above. The one or more servers of the example software distribution platform 2105 are in communication with an example network 2110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 1732 and/or the machine-readable instructions 1832 from the software distribution platform 2105. For example, the software, which may correspond to the example machine-readable instructions of FIG. 10-13, may be downloaded to the example programmable circuitry platform 1700, which is to execute the machine-readable instructions 1732 to implement the compute device 105. As another example, the software, which may correspond to the example machine-readable instructions of FIG. 14-16, may be downloaded to the example programmable circuitry platform 1800, which is to execute the machine-readable instructions 1832 to implement the server 115. In some examples, one or more servers of the software distribution platform 2105 periodically offer, transmit, and/or force updates to the software (e.g., the example machine-readable instructions 1732 of FIG. 17 and/or the machine-readable instructions 1832) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement adaptive image sharpening based on artificial intelligence. Disclosed systems, apparatus, articles of manufacture, and methods improve the efficiency of using a computing device to display data by providing example adaptive image sharpening techniques that produce sharpened images with improved text readability through the power of AI processing, but without the computational and energy overhead of real-time AI model execution. Also, example adaptive image sharpening techniques disclosed herein can be tailored for specific use-cases, such as gaming scenarios, video calls/webcasts, image up-scaling, etc. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, machine-readable instructions, and at least one programmable circuit to be programmed based on the machine-readable instructions to compute respective brightness parameters and respective contrast parameters for corresponding pixels of a first image, determine respective sharpening strength parameters for the corresponding pixels based on the respective brightness parameters and the respective contrast parameters, and generate a second image based on the first image and the sharpening strength parameters.

Example 2 includes the apparatus of example 1, wherein the respective brightness parameters have values in a range of negative one to positive one.

Example 3 includes the apparatus of example 1 or example 2, wherein one or more of the at least one programmable circuit is to compute a first one of the respective brightness parameters for a corresponding first one of the pixels based on a neighborhood of pixels of the first image, the neighborhood of pixels including the corresponding first one of the pixels.

Example 4 includes the apparatus of example 3, wherein one or more of the at least one programmable circuit is to apply a kernel to respective luminance values of corresponding ones of the pixels in the neighborhood of pixels to compute the first one of the respective brightness parameters.

Example 5 includes the apparatus of any one of examples 1 to 4, wherein one or more of the at least one programmable circuit is to compute a first one of the respective contrast parameters for a corresponding first one of the pixels based on a neighborhood of pixels of the first image, the neighborhood of pixels including the corresponding first one of the pixels.

Example 6 includes the apparatus of example 5, wherein one or more of the at least one programmable circuit is to determine a maximum luminance value among the pixels in the neighborhood of pixels, determine a minimum luminance value among the pixels in the neighborhood of pixels, and compute the first one of the respective contrast parameters based on a difference between the maximum luminance value and the minimum luminance value.

Example 7 includes the apparatus of any one of examples 1 to 6, wherein one or more of the at least one programmable circuit is to compute the respective sharpening strength parameters based on a data structure including reference sharpening strength parameters mapped to combinations of brightness index values and contrast index values.

Example 8 includes the apparatus of example 7, wherein the data structure is a two-dimensional look-up table indexed by the brightness index values along a first dimension and indexed by the contrast index values along a second dimension.

Example 9 includes the apparatus of example 7 or example 8, wherein one or more of the at least one programmable circuit is to retrieve a first reference sharpening strength parameter and a second reference sharpening strength parameter from the data structure based on a first one of the respective brightness parameters and a first one of the respective contrast parameters for a corresponding first one of the pixels, and compute a first one of the respective sharpening strength parameters for the first corresponding one of the pixels based on interpolation between the first reference sharpening strength parameter and the second reference sharpening strength parameter.

Example 10 includes the apparatus of example 9, wherein one or more of the at least one programmable circuit is to compute an interpolated value based on the interpolation between the first reference sharpening strength parameter and the second reference sharpening strength parameter, and multiply the interpolated value with a scale factor to compute the first one of the respective sharpening strength parameters for the first corresponding one of the pixels.

Example 11 includes the apparatus of any one of examples 7 to 10, wherein one or more of the at least one programmable circuit is to initialize the data structure based on an application associated with the first image.

Example 12 includes the apparatus of any one of examples 7 to 11, wherein the reference sharpening strength parameters are based on an artificial intelligence model.

Example 13 includes the apparatus of any one of examples 1 to 12, wherein the corresponding pixels of the first image are first pixels, the second image includes second pixels, and one or more of the at least one programmable circuit is to blur the first image to generate a third image including third pixels, compute a difference between a luminance value of a first one of the first pixels of the first image and a luminance value of one of the third pixels of the third image at a location corresponding to the first one of the first pixels, and compute a luminance value of one of the second pixels of the second image at the location corresponding to the first one of the first pixels based on addition of the luminance value of the first one of the first pixels to a result of multiplication of the difference by a first one of the sharpening strength parameters corresponding to the first one of the first pixels.

Example 14 includes the apparatus of example 13, wherein one or more of the at least one programmable circuit is to clip the luminance value of the one of the second pixels of the second image based on a programmable range of output luminance values.

Example 15 includes at least one non-transitory computer-readable medium comprising computer-readable instructions to cause at least one programmable circuit to at least compute respective brightness parameters and respective contrast parameters for corresponding pixels of a first image, determine respective sharpening strength parameters for the corresponding pixels based on the respective brightness parameters and the respective contrast parameters, and generate a second image based on the first image and the sharpening strength parameters.

Example 16 includes the at least one non-transitory computer-readable medium of example 15, wherein the respective brightness parameters have values in a range of negative one to positive one.

Example 17 includes the at least one non-transitory computer-readable medium of example 15 or example 16, wherein the instructions are to cause one or more of the at least one programmable circuit to compute a first one of the respective brightness parameters for a corresponding first one of the pixels based on a neighborhood of pixels of the first image, the neighborhood of pixels including the corresponding first one of the pixels.

Example 18 includes the at least one non-transitory computer-readable medium of example 17, wherein the instructions are to cause one or more of the at least one programmable circuit to apply a kernel to respective luminance values of corresponding ones of the pixels in the neighborhood of pixels to compute the first one of the respective brightness parameters.

Example 19 includes the at least one non-transitory computer-readable medium of any one of examples 15 to 18, wherein the instructions are to cause one or more of the at least one programmable circuit to compute a first one of the respective contrast parameters for a corresponding first one of the pixels based on a neighborhood of pixels of the first image, the neighborhood of pixels including the corresponding first one of the pixels.

Example 20 includes the at least one non-transitory computer-readable medium of example 19, wherein the instructions are to cause one or more of the at least one programmable circuit to determine a maximum luminance value among the pixels in the neighborhood of pixels, determine a minimum luminance value among the pixels in the neighborhood of pixels, and compute the first one of the respective contrast parameters based on a difference between the maximum luminance value and the minimum luminance value.

Example 21 includes the at least one non-transitory computer-readable medium of any one of examples 15 to 20, wherein the instructions are to cause one or more of the at least one programmable circuit to compute the respective sharpening strength parameters based on a data structure including reference sharpening strength parameters mapped to combinations of brightness index values and contrast index values.

Example 22 includes the at least one non-transitory computer-readable medium of example 21, wherein the data structure is a two-dimensional look-up table indexed by the brightness index values along a first dimension and indexed by the contrast index values along a second dimension.

Example 23 includes the at least one non-transitory computer-readable medium of example 21 or example 22, wherein the instructions are to cause one or more of the at least one programmable circuit to retrieve a first reference sharpening strength parameter and a second reference sharpening strength parameter from the data structure based on a first one of the respective brightness parameters and a first one of the respective contrast parameters for a corresponding first one of the pixels, and compute a first one of the respective sharpening strength parameters for the first corresponding one of the pixels based on interpolation between the first reference sharpening strength parameter and the second reference sharpening strength parameter.

Example 24 includes the at least one non-transitory computer-readable medium of example 23, wherein the instructions are to cause one or more of the at least one programmable circuit to compute an interpolated value based on the interpolation between the first reference sharpening strength parameter and the second reference sharpening strength parameter, and multiply the interpolated value with a scale factor to compute the first one of the respective sharpening strength parameters for the first corresponding one of the pixels.

Example 25 includes the at least one non-transitory computer-readable medium of any one of examples 21 to 24, wherein the instructions are to cause one or more of the at least one programmable circuit to initialize the data structure based on an application associated with the first image.

Example 26 includes the at least one non-transitory computer-readable medium of any one of examples 21 to 25, wherein the reference sharpening strength parameters are based on an artificial intelligence model.

Example 27 includes the at least one non-transitory computer-readable medium of any one of examples 15 to 26, wherein the corresponding pixels of the first image are first pixels, the second image includes second pixels, and the instructions are to cause one or more of the at least one programmable circuit to blur the first image to generate a third image including third pixels, compute a difference between a luminance value of a first one of the first pixels of the first image and a luminance value of one of the third pixels of the third image at a location corresponding to the first one of the first pixels, and compute a luminance value of one of the second pixels of the second image at the location corresponding to the first one of the first pixels based on addition of the luminance value of the first one of the first pixels to a result of multiplication of the difference by a first one of the sharpening strength parameters corresponding to the first one of the first pixels.

Example 28 includes the at least one non-transitory computer-readable medium of example 27, wherein the instructions are to cause one or more of the at least one programmable circuit to clip the luminance value of the one of the second pixels of the second image based on a programmable range of output luminance values.

Example 29 includes a method comprising computing respective brightness parameters and respective contrast parameters for corresponding pixels of a first image, determining respective sharpening strength parameters for the corresponding pixels based on the respective brightness parameters and the respective contrast parameters, and generating a second image based on the first image and the sharpening strength parameters.

Example 30 includes the method of example 29, wherein the respective brightness parameters have values in a range of negative one to positive one.

Example 31 includes the method of example 29 or example 30, wherein the computing of the respective brightness parameters includes computing a first one of the respective brightness parameters for a corresponding first one of the pixels based on a neighborhood of pixels of the first image, the neighborhood of pixels including the corresponding first one of the pixels.

Example 32 includes the method of example 31, including applying a kernel to respective luminance values of corresponding ones of the pixels in the neighborhood of pixels to compute the first one of the respective brightness parameters.

Example 33 includes the method of any one of examples 29 to 32, wherein the computing of the respective contrast parameters includes computing a first one of the respective contrast parameters for a corresponding first one of the pixels based on a neighborhood of pixels of the first image, the neighborhood of pixels including the corresponding first one of the pixels.

Example 34 includes the method of example 33, including determining a maximum luminance value among the pixels in the neighborhood of pixels, determining a minimum luminance value among the pixels in the neighborhood of pixels, and computing the first one of the respective contrast parameters based on a difference between the maximum luminance value and the minimum luminance value.

Example 35 includes the method of any one of examples 29 to 34, wherein the computing of the respective sharpening strength parameters is based on a data structure including reference sharpening strength parameters mapped to combinations of brightness index values and contrast index values.

Example 36 includes the method of example 35, wherein the data structure is a two-dimensional look-up table indexed by the brightness index values along a first dimension and indexed by the contrast index values along a second dimension.

Example 37 includes the method of example 35 or example 36, wherein the determining of the respective sharpening strength parameters includes retrieving a first reference sharpening strength parameter and a second reference sharpening strength parameter from the data structure based on a first one of the respective brightness parameters and a first one of the respective contrast parameters for a corresponding first one of the pixels, and computing a first one of the respective sharpening strength parameters for the first corresponding one of the pixels based on interpolation between the first reference sharpening strength parameter and the second reference sharpening strength parameter.

Example 38 includes the method of example 37, wherein the computing of the first one of the respective sharpening strength parameters includes computing an interpolated value based on the interpolation between the first reference sharpening strength parameter and the second reference sharpening strength parameter, and multiplying the interpolated value with a scale factor to compute the first one of the respective sharpening strength parameters for the first corresponding one of the pixels.

Example 39 includes the method of any one of examples 35 to 38, including initializing the data structure based on an application associated with the first image.

Example 40 includes the method of examples 35 to 39, wherein the reference sharpening strength parameters are based on an artificial intelligence model.

Example 41 includes the method of examples 29 to 40, wherein the corresponding pixels of the first image are first pixels, the second image includes second pixels, and including blurring the first image to generate a third image including third pixels, computing a difference between a luminance value of a first one of the first pixels of the first image and a luminance value of one of the third pixels of the third image at a location corresponding to the first one of the first pixels, and computing a luminance value of one of the second pixels of the second image at the location corresponding to the first one of the first pixels based on addition of the luminance value of the first one of the first pixels to a result of multiplication of the difference by a first one of the sharpening strength parameters corresponding to the first one of the first pixels.

Example 42 includes the method of example 41, including clipping the luminance value of the one of the second pixels of the second image based on a programmable range of output luminance values.

Example 43 includes at least one non-transitory computer-readable medium comprising computer-readable instructions to cause at least one programmable circuit to at least obtain training images associated with corresponding ground-truth images, compute respective brightness parameters and respective contrast parameters for corresponding pixels of a first one of the training images, and train an artificial intelligence model based on the first one of the training images, a first one of the ground-truth images corresponding to the first one of the training images, the respective brightness parameters and the respective contrast parameters, the artificial intelligence model to output respective sharpening strength parameters for the corresponding pixels of the first one of the training images, the first one of the training images to be sharpened based on the respective sharpening strength parameters.

Example 44 includes the at least one non-transitory computer-readable medium of example 43, wherein the computer-readable instructions are to cause one or more of the at least one programmable circuit to compute a first one of the respective brightness parameters for a corresponding first one of the pixels based on luminance values of a neighborhood of pixels of the first one of the training images, the neighborhood of pixels including the corresponding first one of the pixels.

Example 45 includes the at least one non-transitory computer-readable medium of example 43 or example 44, wherein the computer-readable instructions are to cause one or more of the at least one programmable circuit to compute a first one of the respective contrast parameters for a corresponding first one of the pixels based on luminance values of a neighborhood of pixels of the first one of the training images, the neighborhood of pixels including the corresponding first one of the pixels.

Example 46 includes the at least one non-transitory computer-readable medium of any one of examples 43 to 45, wherein the artificial intelligence model is to accept as input the respective brightness parameters and the respective contrast parameters for the corresponding pixels of the first one of the training images.

Example 47 includes the at least one non-transitory computer-readable medium of example 46, wherein the computer-readable instructions are to cause one or more of the at least one programmable circuit to sharpen the first one of the training images based on the respective sharpening strength parameters to generate a sharpened image, compute a mean squared error loss, a mean absolute loss and a perceptual loss based on the sharpened image and the first one of the ground-truth images, evaluate a loss function based on the mean squared error loss, the mean absolute loss and the perceptual loss to determine a loss value, and train the artificial intelligence model based on the loss value.

Example 48 includes the at least one non-transitory computer-readable medium of any one of examples 43 to 47, wherein the computer-readable instructions are to cause one or more of the at least one programmable circuit to generate a sequence of brightness index values over a range of brightness values, generate a sequence of contrast index values over a range of contrast values, generate a synthetic input pattern based on combinations of ones of the brightness index values and ones of the contrast index values, apply the synthetic input pattern to the trained artificial intelligence model to obtain output reference sharpening strength parameters corresponding respectively to the combinations of the ones of the brightness index values and the ones of the contrast index values, and cause download of the reference sharpening strength parameters to a compute device.

Example 49 includes an apparatus comprising interface circuitry, machine-readable instructions, and at least one programmable circuit to be programmed based on the machine-readable instructions to obtain training images associated with corresponding ground-truth images, compute respective brightness parameters and respective contrast parameters for corresponding pixels of a first one of the training images, and train an artificial intelligence model based on the first one of the training images, a first one of the ground-truth images corresponding to the first one of the training images, the respective brightness parameters and the respective contrast parameters, the artificial intelligence model to output respective sharpening strength parameters for the corresponding pixels of the first one of the training images, the first one of the training images to be sharpened based on the respective sharpening strength parameters.

Example 50 includes the apparatus of example 49, wherein one or more of the at least one programmable circuit is to compute a first one of the respective brightness parameters for a corresponding first one of the pixels based on luminance values of a neighborhood of pixels of the first one of the training images, the neighborhood of pixels including the corresponding first one of the pixels.

Example 51 includes the apparatus of example 49 or example 50, wherein one or more of the at least one programmable circuit is to compute a first one of the respective contrast parameters for a corresponding first one of the pixels based on luminance values of a neighborhood of pixels of the first one of the training images, the neighborhood of pixels including the corresponding first one of the pixels.

Example 52 includes the apparatus of any one of examples 49 to 51, wherein the artificial intelligence model is to accept as input the respective brightness parameters and the respective contrast parameters for the corresponding pixels of the first one of the training images.

Example 53 includes the apparatus of example 52, wherein one or more of the at least one programmable circuit is to sharpen the first one of the training images based on the respective sharpening strength parameters to generate a sharpened image, compute a mean squared error loss, a mean absolute loss and a perceptual loss based on the sharpened image and the first one of the ground-truth images, evaluate a loss function based on the mean squared error loss, the mean absolute loss and the perceptual loss to determine a loss value, and train the artificial intelligence model based on the loss value.

Example 54 includes the apparatus of any one of examples 49 to 53, wherein one or more of the at least one programmable circuit is to generate a sequence of brightness index values over a range of brightness values, generate a sequence of contrast index values over a range of contrast values, generate a synthetic input pattern based on combinations of ones of the brightness index values and ones of the contrast index values, apply the synthetic input pattern to the trained artificial intelligence model to obtain output reference sharpening strength parameters corresponding respectively to the combinations of the ones of the brightness index values and the ones of the contrast index values, and cause download of the reference sharpening strength parameters to a compute device.

Example 55 includes a method comprising obtaining training images associated with corresponding ground-truth images, computing respective brightness parameters and respective contrast parameters for corresponding pixels of a first one of the training images, and training an artificial intelligence model based on the first one of the training images, a first one of the ground-truth images corresponding to the first one of the training images, the respective brightness parameters and the respective contrast parameters, the artificial intelligence model to output respective sharpening strength parameters for the corresponding pixels of the first one of the training images, the first one of the training images to be sharpened based on the respective sharpening strength parameters.

Example 56 includes the method of example 55, wherein the computing of the respective brightness parameters includes computing a first one of the respective brightness parameters for a corresponding first one of the pixels based on luminance values of a neighborhood of pixels of the first one of the training images, the neighborhood of pixels including the corresponding first one of the pixels.

Example 57 includes the method of example 55 or example 56, wherein the computing of the respective contrast parameters includes computing a first one of the respective contrast parameters for a corresponding first one of the pixels based on luminance values of a neighborhood of pixels of the first one of the training images, the neighborhood of pixels including the corresponding first one of the pixels.

Example 58 includes the method of examples 55 to 57, wherein the artificial intelligence model is to accept as input the respective brightness parameters and the respective contrast parameters for the corresponding pixels of the first one of the training images.

Example 59 includes the method of example 58, including sharpening the first one of the training images based on the respective sharpening strength parameters to generate a sharpened image, computing a mean squared error loss, a mean absolute loss and a perceptual loss based on the sharpened image and the first one of the ground-truth images, evaluating a loss function based on the mean squared error loss, the mean absolute loss and the perceptual loss to determine a loss value, and train the artificial intelligence model based on the loss value.

Example 60 includes the method of any one of examples 55 to 59, including generating a sequence of brightness index values over a range of brightness values, generating a sequence of contrast index values over a range of contrast values, generating a synthetic input pattern based on combinations of ones of the brightness index values and ones of the contrast index values, applying the synthetic input pattern to the trained artificial intelligence model to obtain output reference sharpening strength parameters corresponding respectively to the combinations of the ones of the brightness index values and the ones of the contrast index values, and causing download of the reference sharpening strength parameters to a compute device.

Example 61 includes at least one machine-readable medium comprising machine-readable instructions to cause at least one programmable circuit to perform the method of any one of examples 29 to example 42.

Example 62 includes at least one machine-readable medium comprising machine-readable instructions to cause at least one programmable circuit to perform the method of any one of examples 55 to example 60.

Example 63 includes an apparatus to perform the method of any one of examples 29 to example 42.

Example 64 includes an apparatus to perform the method of any one of examples 55 to example 60.

Example 65 includes a method performed by any one of the apparatus of examples 1 to example 14.

Example 66 includes a method performed by any one of the apparatus of examples 49 to example 54.

Example 67 includes at least one machine-readable medium comprising the machine-readable instructions of any one of the apparatus of examples 1 to example 14.

Example 68 includes at least one machine-readable medium comprising the machine-readable instructions of any one of the apparatus of examples 49 to example 54 includes

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed based on the machine-readable instructions to:
compute respective brightness parameters and respective contrast parameters for corresponding pixels of a first image;
determine respective sharpening strength parameters for the corresponding pixels based on the respective brightness parameters and the respective contrast parameters; and
generate a second image based on the first image and the sharpening strength parameters.

2. The apparatus of claim 1, wherein the respective brightness parameters have values in a range of negative one to positive one.

3. The apparatus of claim 1, wherein one or more of the at least one programmable circuit is to compute a first one of the respective brightness parameters for a corresponding first one of the pixels based on a neighborhood of pixels of the first image, the neighborhood of pixels including the corresponding first one of the pixels.

4. The apparatus of claim 3, wherein one or more of the at least one programmable circuit is to apply a kernel to respective luminance values of corresponding ones of the pixels in the neighborhood of pixels to compute the first one of the respective brightness parameters.

5. The apparatus of claim 1, wherein one or more of the at least one programmable circuit is to compute a first one of the respective contrast parameters for a corresponding first one of the pixels based on a neighborhood of pixels of the first image, the neighborhood of pixels including the corresponding first one of the pixels.

6. The apparatus of claim 5, wherein one or more of the at least one programmable circuit is to:
determine a maximum luminance value among the pixels in the neighborhood of pixels;
determine a minimum luminance value among the pixels in the neighborhood of pixels; and
compute the first one of the respective contrast parameters based on a difference between the maximum luminance value and the minimum luminance value.

7. The apparatus of claim 1, wherein one or more of the at least one programmable circuit is to compute the respective sharpening strength parameters based on a data structure including reference sharpening strength parameters mapped to combinations of brightness index values and contrast index values.

8. The apparatus of claim 7, wherein the data structure is a two-dimensional look-up table indexed by the brightness index values along a first dimension and indexed by the contrast index values along a second dimension.

9. The apparatus of claim 7, wherein one or more of the at least one programmable circuit is to:
retrieve a first reference sharpening strength parameter and a second reference sharpening strength parameter from the data structure based on a first one of the respective brightness parameters and a first one of the respective contrast parameters for a corresponding first one of the pixels; and
compute a first one of the respective sharpening strength parameters for the first corresponding one of the pixels based on interpolation between the first reference sharpening strength parameter and the second reference sharpening strength parameter.

10. The apparatus of claim 9, wherein one or more of the at least one programmable circuit is to:
compute an interpolated value based on the interpolation between the first reference sharpening strength parameter and the second reference sharpening strength parameter; and
multiply the interpolated value with a scale factor to compute the first one of the respective sharpening strength parameters for the first corresponding one of the pixels.

11. The apparatus of claim 7, wherein one or more of the at least one programmable circuit is to initialize the data structure based on an application associated with the first image.

12. The apparatus of claim 7, wherein the reference sharpening strength parameters are based on an artificial intelligence model.

13. The apparatus of claim 1, wherein the corresponding pixels of the first image are first pixels, the second image includes second pixels, and one or more of the at least one programmable circuit is to:
blur the first image to generate a third image including third pixels;
compute a difference between a luminance value of a first one of the first pixels of the first image and a luminance value of one of the third pixels of the third image at a location corresponding to the first one of the first pixels; and
compute a luminance value of one of the second pixels of the second image at the location corresponding to the first one of the first pixels based on addition of the luminance value of the first one of the first pixels to a result of multiplication of the difference by a first one of the sharpening strength parameters corresponding to the first one of the first pixels.

14. The apparatus of claim 13, wherein one or more of the at least one programmable circuit is to clip the luminance value of the one of the second pixels of the second image based on a programmable range of output luminance values.

15. At least one non-transitory computer-readable medium comprising computer-readable instructions to cause at least one programmable circuit to at least:
obtain training images associated with corresponding ground-truth images;
compute respective brightness parameters and respective contrast parameters for corresponding pixels of a first one of the training images; and
train an artificial intelligence model based on the first one of the training images, a first one of the ground-truth images corresponding to the first one of the training images, the respective brightness parameters and the respective contrast parameters, the artificial intelligence model to output respective sharpening strength parameters for the corresponding pixels of the first one of the training images, the first one of the training images to be sharpened based on the respective sharpening strength parameters.

16. The at least one non-transitory computer-readable medium of claim 15, wherein the computer-readable instructions are to cause one or more of the at least one programmable circuit to compute a first one of the respective brightness parameters for a corresponding first one of the pixels based on luminance values of a neighborhood of pixels of the first one of the training images, the neighborhood of pixels including the corresponding first one of the pixels.

17. The at least one non-transitory computer-readable medium of claim 15, wherein the computer-readable instructions are to cause one or more of the at least one programmable circuit to compute a first one of the respective contrast parameters for a corresponding first one of the pixels based on luminance values of a neighborhood of pixels of the first one of the training images, the neighborhood of pixels including the corresponding first one of the pixels.

18. The at least one non-transitory computer-readable medium of claim 15, wherein the artificial intelligence model is to accept as input the respective brightness parameters and the respective contrast parameters for the corresponding pixels of the first one of the training images.

19. The at least one non-transitory computer-readable medium of claim 18, wherein the computer-readable instructions are to cause one or more of the at least one programmable circuit to:
sharpen the first one of the training images based on the respective sharpening strength parameters to generate a sharpened image;
compute a mean squared error loss, a mean absolute loss and a perceptual loss based on the sharpened image and the first one of the ground-truth images;
evaluate a loss function based on the mean squared error loss, the mean absolute loss and the perceptual loss to determine a loss value; and
train the artificial intelligence model based on the loss value.

20. The at least one non-transitory computer-readable medium of claim 15, wherein the computer-readable instructions are to cause one or more of the at least one programmable circuit to:
generate a sequence of brightness index values over a range of brightness values;
generate a sequence of contrast index values over a range of contrast values;
generate a synthetic input pattern based on combinations of ones of the brightness index values and ones of the contrast index values;
apply the synthetic input pattern to the trained artificial intelligence model to obtain output reference sharpening strength parameters corresponding respectively to the combinations of the ones of the brightness index values and the ones of the contrast index values; and
cause download of the reference sharpening strength parameters to a compute device.
